(19) United States
(12) Patent Application Publication
(10) Pub. No.: US 2013/0216648 A1
(43) Pub. Date: Aug. 22, 2013

(54) CHEWING GUM COMPOSITIONS PROVIDING FLAVOR RELEASE PROFILES

(71) Applicants: Sandra Lenzi, Bloomfield, NJ (US); Simkie Kar, Hackensack, NJ (US); Tasoula A. Michaelidou, Cresskill, NJ (US); Joan E. Harvey, Easton, PA (US); Matthew Allen Beam, Alexandria, KY (US); Demetrius Torino McCormick, Clinton, NJ (US); Simman Wong, East Brunswick, NJ (US); Junjie Guan, Tenafly, NJ (US); Deborah Levenson, Morristown, NJ (US); Juan Pablo Campomanes Marin, Puebla (MX)

(72) Inventors: Sandra Lenzi, Bloomfield, NJ (US); Simkie Kar, Hackensack, NJ (US); Tasoula A. Michaelidou, Cresskill, NJ (US); Joan E. Harvey, Easton, PA (US); Matthew Allen Beam, Alexandria, KY (US); Demetrius Torino McCormick, Clinton, NJ (US); Simman Wong, East Brunswick, NJ (US); Junjie Guan, Tenafly, NJ (US); Deborah Levenson, Morristown, NJ (US); Juan Pablo Campomanes Marin, Puebla (MX)

(73) Assignee: KRAFT FOODS GLOBAL BRANDS LLC, Deerfield, IL (US)

(21) Appl. No.: 13/821,296

(22) PCT Filed: Sep. 9, 2011
(86) PCT No.: PCT/US2011/050991

§ 371 Date: Mar. 18, 2013

Related U.S. Application Data
(60) Provisional application No. 61/381,171, filed on Sep. 9, 2010.

(51) Int. Cl. A23G 4/06

(52) U.S. Cl. CPC A23G 4/06
USPC 426/3

(57) ABSTRACT

A chewing gum composition including at least three flavor compositions providing a unique and long-lasting flavor sensations to the consumer.

### BACKGROUND OF THE INVENTION

1. Field of the Invention

A chewing gum composition including at least three flavor compositions providing a unique and long-lasting flavor sensations to the consumer.

2. Description of the Background

High intensity sweeteners as well as flavors are commonly known and used in chewing gum formulations.

Typically, the taste profile of a high intensity sweetener can be described as a rapid burst of sweetness. Usually, high intensity sweeteners reach their peak sweet taste rapidly, with the intensity of sweet taste rapidly declining soon thereafter. The initial rapid burst can be unpleasant to many consumers as the strong sweet taste tends to overpower the other flavors that may be present in the edible composition. The relatively rapid loss of sweetness can also result in a bitter aftertaste. For this reason, we have previously described encapsulating high intensity sweeteners with an encapsulating material to modulate and prolong the release profile and to chemically stabilize and enhance the overall taste profile.

Tensile strengths of about and exceeding 6,500 psi in the encapsulation systems described previously delay active ingredient release from chewable compositions. The release rate of encapsulated actives, such as sweeteners, flavors, functional ingredients, and the like were described to depend on the tensile strength, hydrophobicity, particle size, distribution, degree of dispersion and chemical stability of encapsulations. See US PG PUBS 2007/0298061, 2006/0263480, 2006/0263479, 2006/0263478, 2006/0263477, 2006/0263473, 2006/0263472, 2006/0263413, 2006/0193896, 2006/0034897, 2005/0220867, 2005/0214348, and 2005/0112236. Also, for example, providing multiple flavors and release profiles with multiple points of interest such that the multiple flavors are delivered at different rates had been described in WO 2006/127685, U.S. 4,775,537 and EP 01 23524. EP 01 23524 describes the combination of liquid flavor and encapsulated flavor to provide plural release times for flavors.

### SUMMARY OF THE INVENTION

The inventors have found that to provide a chewing gum delivering multiple, for example distinct, flavors to the consumer, both the compositional make up of the flavors being delivered, how and when they are delivered are important. The inventors describe here how to provide a pleasant and satisfactory chewing experience to the consumer with a multiple flavor chewing gum.

In one embodiment, the invention provides a chewing gum composition, comprising a gum base and at least a first, second and third flavor composition wherein the at least one first flavor composition begins to release from the chewing gum composition when the chewing gum composition is masticated, the at least one second flavor composition begins to release after the at least one first flavor composition has begun to release, and the at least one third flavor composition releases after the second flavor composition begins to release.

In another embodiment, at least one first flavor composition has at least one first peak flavor intensity after the chewing gum composition is masticated and wherein the at least one second flavor composition reaches at least a second peak flavor intensity after the at least one first flavor composition reaches the at least one first peak flavor intensity.

In another embodiment, the at least one third flavor composition reaches at least one third peak flavor intensity after the at least one second flavor composition reaches the at least one second peak flavor intensity.

In another embodiment, the at least one second flavor composition begins to release when the at least one second flavor composition has released for from 15 to 40 seconds.

In another embodiment, the at least one third flavor composition begin to release when the at least one second flavor composition has released for from 15 to 40 seconds.

In another embodiment, the second flavor composition begins to release when the at least one first flavor composition has reached at least from 50 to 100% of the at least one peak flavor intensity.

In another embodiment, the at least one third flavor composition begins to release when the at least one second flavor composition has reached at least from 50 to 100% of the at least one peak flavor intensity.

In another embodiment, the at least one second flavor composition begins to release when at least about 50% of the at least one first flavor composition has released from the chewing gum composition.

In another embodiment, the at least one third flavor composition begins to release when at least about 50% of the at least one second composition has released from the chewing gum composition.

In another embodiment, the at least one first flavor composition comprises a fruit flavor.

In another embodiment, the at least one second flavor composition comprises a fruit flavor and a mint flavor.

In another embodiment, the at least one third flavor composition comprises a mint flavor.

In another embodiment, the at least one first flavor composition comprises a liquid flavor.

In another embodiment, the liquid flavor is a hit flavor.

In another embodiment, the liquid flavor is present in an amount of 0.4% w/w.

In another embodiment, the at least one second flavor composition comprises a particulate flavor delivery system.

In another embodiment, the at least one third flavor composition comprises a particulate delivery system comprising flavor, gelatin, and fat.

In another embodiment, the at least one third flavor composition comprises a particulate delivery system comprising a polymeric encapsulating material and a flavor, wherein the particulate delivery system has a tensile strength of at least 6,500 psi.

In another embodiment, one or more of the first, second and third compositions comprising one or more sweeteners.

In another embodiment, the gum base includes at least 7% w/w by weight of said gum base of butyl rubber.

In another embodiment, the third flavor includes N-(4-cyanomethylphenyl)-p-menthane carboxamide.

In another embodiment, the chewing gum composition also comprises at least one hydrocolloid, for example, in an amount of from 1.5 to 20% by weight of the chewing gum composition and, for example, the hydrocolloid is crosslinked and at least partially encapsulates one or more flavors, e.g., wherein the crosslinked hydrocolloid encapsulates at least one flavor in the at least one second flavor composition and/or the hydrocolloid is selected from the group consisting of low viscosity alginate, medium viscosity alginate, high viscosity alginate, propylene glycol alginate, carrageenan, guar gum, xanthan gum, pectin, hydroxpropyl methyl cellulose, pullulan, gum Arabic, agar, carboxymethyl cellulose, konjac, gellan gum, gelatin, and combinations thereof. The hydrocolloid can be in dry powder form, slurry form, or film form.

Another embodiment of the invention is a method of malting a chewing gum composition, comprising mixing a water-insoluble gum base portion with at least a first, second and third flavor compositions wherein the at least one first flavor composition begins to release from the chewing gum composition when the chewing gum composition is masticated, the at least one second flavor composition begins to release after the at least one first flavor composition has begun to release, and the at least one third flavor composition releases after the second flavor composition begins to release.

In one embodiment of this method, the mixing is performed in a batch mixer.

In one embodiment of this method, the mixing is performed in an extruder.

In one embodiment of this method, the mixing is performed in a batch mixer and an extruder.

In one embodiment of this method, the first, second and third flavor compositions are mixed with the gum base simultaneously.

In one embodiment of this method, the first, second and third flavor compositions are mixed with the gum base separately.

### BRIEF DESCRIPTION OF THE DRAWINGS

FIG. 1 depicts the results of a consumer science study of the strawberry mint chewing gum in Example 15.

FIG. 2 depicts the results of a consumer science study of the strawberry mint chewing gum in Example 16.

FIG. 3 depicts the results of a consumer science study of the strawberry mint chewing gum in Example 17.

FIG. 4 depicts the results of a consumer science study of the strawberry mint chewing gum in Example 18.

FIG. 5 depicts the results of a consumer science study of the citrus mint chewing gum in Example 19.

FIG. 6 depicts the results of a consumer science study of the citrus mint chewing gum in Example 20.

### DETAILED DESCRIPTION OF THE INVENTION

The invention provides a chewing gum composition. As described herein in more detail and as known in the art, chewing gum typically is composed of two parts, a water-insoluble gum base composed of polymeric material and water-soluble ingredients, such as flavors and sweeteners.

The invention here is to the delivery of sweetener(s) and/or flavorant(s) and, in particular, the controlled delivery of at least three flavorants (flavors) at specific times relative to the release profile of the previous flavorant. As used herein when flavorants or flavors are discussed in the context of a chewing gum composition, we mean compositions containing those flavorants, such that a single composition can include only a single flavor or multiple flavors, e.g., 2, 3, 4, 5 or more, with or without a carrier, such as talc or other fillers, and/or as discussed herein below in free form or encapsulated within a delivery system that controls when the flavor is released.

While delaying and controlling release of actives, such as flavors and sweeteners had been described previously, the inventors found that to control the release profile of three actives to provide a unique and prolonged chewing sensation for the consumer, selection of specific materials and flavors were needed. In one aspect of the invention when providing controlled release of distinct flavors such as hit flavors and mint flavors in a single chewing gum, the mint flavor, owing to its perceived intensity, interferes with the perception of the fruit flavors. To try and counteract this effect, simply parsing each flavor into distinct release profiles (one early and one later) was not sufficient, as there remained the problem that the mint flavor overpowered the fruit flavor. The inventors have found that by providing a transitional flavor composition, for example, composed of the two flavors, between the releases of the two flavors, the perception that is desired by the consumer without causing interference between the two flavors could be achieved.

More specifically, each of the at least first, second and third flavor compositions have a first peak flavor intensity. So for purposes of illustration only and the example discussed in the preceding paragraph, the first composition of flavor can be fruit, the third composition of flavor can be mint and the second can be a combination of fruit and mint.

Peak flavor intensity can be measured according to known measurement techniques, either quantitatively in the lab measuring the amount of a particular flavor released during simulated chew-out studies or measured quantitatively by a trained panel of experts who assess that peak intensity according to standard protocols in the art. Peak intensity and measurement thereof is from the starting point of mastication (chewing) the chewing gum composition as that starting point is t=0 seconds.

The first flavor composition will release from the chewing gum composition when the chewing gum composition is masticated. Preferably, the first flavor composition reaches it peak intensity at about 30 seconds, such as from 15-45 seconds, 20-40 seconds, and 25-35 seconds, including all values and ranges there between.

The first flavor composition is preferably an unencapsulated or free flavor composition and preferably comprises at least one flavor that is in liquid form. By providing an unencapsulated flavor, immediate release of the flavor reaching the peak intensity for this first flavor composition can be achieved. As used herein, the term “unencapsulated” refers to flavor(s) and flavor delivery systems that provide an immediate release. As used herein, the term “immediate release” refers to flavor(s) and flavor delivery systems that provide flavor release during the initial chew in time frames from about 0-45 seconds.

In some embodiments, the at least one first liquid flavor composition is in an amount of from about 0.05% to about 1.0% w/w by weight of the chewing gum composition. In other embodiments, the at least one first liquid flavor is in an amount of not more than 1.0% w/w by weight of the chewing gum composition while in a preferred embodiment, the at least one liquid flavor is in an amount of not more than 0.5% w/w by weight of the chewing gum composition.

In some embodiments, the at least one first flavor composition is a flavor provided as a solid. In some embodiments, the first solid flavor composition can include an immediate release, dry format flavor which can include, but is not limited, to spray dried flavors. In some embodiments, the solid form of the at least one first flavor composition is a spray dried flavor in an amount of from about 0.1% to about 1.0% w/w based on the weight of the chewing gum composition. In other embodiments, the at least one first solid flavor is in an amount of not more than 1.0% w/w by weight of the chewing gum composition while in a preferred embodiment, the at least one first solid flavor is in an amount of not more than 0.6% w/w by weight of the chewing gum composition. The inventors have discovered that the at least one first solid flavor amount can vary more widely than the amounts of the at least one second and the at least one third flavor. While not wishing to be bound to any theory as to why the amount of the at least one first solid flavor can vary more widely, the inventors have found that the tendency for the at least one first solid flavor to release quickly and not linger throughout the chew, may explain the larger tolerance for a wider range of amount of the at least one first solid flavor.

In some embodiments, the at least one first flavor composition is a flavor provided as a combination of liquid and solid forms. In some embodiments, the at least one first flavor composition includes a liquid flavor in an amount of from about 0.05% to about 1.0% W/W by weight of the chewing gum composition and a solid flavor in an amount of from about 0.2% to about 1.0% w/w by weight of the chewing gum composition. In other embodiments, the at least one first liquid flavor is in an amount of not more than 1.0% W/W by weight of the chewing gum composition and the at least one solid flavor is in an amount of not more than 1.0% w/w by weight of the chewing gum composition. In a preferred embodiment, the at least one liquid flavor is in an amount of not more than 0.5% W/W by weight of the chewing gum composition and the at least one first solid flavor is in an amount of not more than 0.6% w/w by weight of the chewing gum composition.

In one aspect of the invention, the at least one second flavor composition begins to release after the at least one first flavor composition has begun to release.

In another aspect of the invention, the at least one second flavor composition reaches at least a second peak flavor intensity after the at least one first flavor composition reaches the at least one first peak flavor intensity.

In another aspect of the invention, the at least one second flavor composition begins to release when the at least one first flavor composition has released for from 15 to 40 seconds, including 20, 25, 30, 35 seconds and all values and ranges there between. In another aspect of the invention, the second flavor composition begins to release when the at least one first flavor composition has reached at least from 50 to 100% of the at least one peak flavor intensity, including 60, 70, 80, 90, 95% and all values and ranges there between.

In another aspect of the invention, the at least one second flavor composition begins to release when at least about 50% of the at least one first flavor composition has released from the chewing gum composition, including at least 60, 70, 75, 80,90, 95, 97%, and all values and ranges there between.

In another aspect of the invention, the at least one second flavor composition reaches a second peak flavor intensity after the at least one first flavor composition reaches the first peak flavor intensity So, for example, if the peak flavor intensity of the first flavor composition reaches its peak at 30 seconds, the second flavor composition shall reach its flavor peak after 30 seconds, for example, 5 seconds after the first, including 10 seconds, 15, seconds, 20 seconds, 25 seconds, 30 seconds, and all values and ranges there between. In a preferred aspect, the second flavor has a peak flavor intensity from about 30 to about 90 seconds, such as 30 to 60 and 30 to 45, including all values and ranges there between, after mastication (t=0 seconds).

Preferably, the second flavor composition comprises at least two flavors and more preferably, the at least two flavors includes at least one flavor of the first flavor composition and at least one flavor of the third flavor composition. One example of such a two component flavor composition is described in U.S. Pat. No. 4,775,537, the relevant contents of which are incorporated herein by reference. As described in U.S. Pat. No. 4,775,537, sequential flavoring agent release uses non-confined flavoring agents of differing solubilities and therefore differing rates of release into the mouth of a chewer when the compositions are chewed. More particularly, in one embodiment, water soluble flavoring agents and oil soluble flavoring agents are used. The oil soluble flavoring agents, during chewing, are released after the water soluble flavoring agents are released. In another embodiment only oil soluble flavoring agents. The oil soluble flavoring agents having different solubilities and rates of release provide flavor in a sequential manner.

Those skilled in the art will appreciate that in the selection of the water soluble and oil soluble flavoring agents, those agents will be used which are compatible with each other and which therefore will not adversely react with one another. Preferably only one water soluble flavoring agent is used and only one oil soluble flavoring agent is used in the embodiment using these flavoring agents. In the embodiment using only oil soluble flavoring agents, preferably two different oil soluble flavoring agents are used. Those skilled in the art will also appreciate that reference to the solubility of the flavoring agents is a way of making reference to the release rates and sequence of release of the flavoring agents into the mouth of the chewer when the chewing gum compositions are chewed. Thus, a more soluble flavoring agent, in comparison to a less soluble flavoring agent, will release before the less soluble flavoring agent releases.

In general, the water soluble flavoring agents are within the range of about 0.05% to about 20% by weight of the total composition with about 0.05% to about 5% by weight being preferred, about 0.5% to about 3% by weight being more preferred and about 1.5% to about 3% being most preferred. In general, the oil soluble flavoring agents are within the range of about 0.05% to about 5% by weight of the total composition with about 0.05% to about 2.0% by weight being preferred and about 0.05% to about 1.5% by weight being most preferred.

Water soluble, as used herein, means that the solubility of the flavoring agent in water is from slightly soluble to completely soluble. Preferably the water soluble flavoring agent is one that is moderately soluble to completely soluble in water and most preferably is one that is very soluble to completely soluble and even more preferably is one that is completely soluble. In general, the water soluble flavoring agents utilizable are those from which at least a 5% by weight solution can be made. Oil soluble, as used herein, means the solubility of the oil soluble flavoring agent in water is from very slightly soluble to insoluble. In general, when an oil soluble flavoring agent is mixed with water two phases are formed, an oil phase and a water phase, with substantially all of the oil soluble flavoring agent being in the oil phase.

Representative oil soluble flavoring agents include: spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, peanut butter flavor, chocolate flavor, rum flavor, cassia oil, cinnamon mint flavor, corn mint oil, cardamom flavor, ginger flavor, cola flavor, cherry cola flavor, and the like. Representative water soluble flavoring agents include: artificial, natural or synthetic fruit flavors, such as vanilla, and citrus essences, including lemon, orange, grape, lime and grapefruit and fruit essences including apple, pear, peach, strawberry, raspberry, cherry, plum, cranberry, pineapple, apricot, black currant, mixed fruit (e.g. tutti frutti) and various plant parts and extracts of plant parts such as carob, coffee, licorice and so forth.

In other embodiments, the second flavor composition comprises a delivery system as described in US PG publications 2007/0298061, 2006/0263480, 2006/0263479, 2006/0263478, 2006/0263477, 2006/0263473, 2006/0263472, 2006/0263413, 2006/0193896, 2006/0034897, 2005/0220867, 2005/0214348, and/or 2005/0112236, the relevant disclosures for which are incorporated herein by reference.

The delivery system includes encapsulating material that forms a matrix with the at least one active component whereby the encapsulating material can completely encapsulate at least one active component, can partially encapsulate the at least one active component, or can associate with the at least one active component whereby the encapsulating material provides controlled and/or delayed release of the at least one active component in accordance with the description herein.

In one aspect of the present invention, the release profile of the active components can be managed by formulating the delivery system based on the hydrophobicity of the encapsulating material, e.g., polymer. Using highly hydrophobic polymers to form a delivery system, the release of the active component can be delayed during consumption of an edible product that includes the delivery system. In a similar manner, using encapsulating material that is less hydrophobic, the active components can be released earlier or more rapidly.

Hydrophobicity can be quantitated by the relative water-absorption measured according to American Society of Testing Materials in method number ASTM D570-98. Thus, by selecting encapsulating material with relatively lower water-absorption properties and adding that to the mixer, the release of the active component contained in the produced delivery system can be delayed compared to those encapsulating materials having higher water-absorption properties. In certain embodiments, a delivery system with encapsulation material having a water absorption of from about 50 to 100% (as measured according to ASTM D570-98) can be used. To decrease the relative delivery rate of the active components or delay release of the active components, the encapsulating material can be selected such that the water absorption would be from about 15 to about 50% (as measured according to ASTM D570-98). Still further, in other embodiments, the water absorption properties of the encapsulating material can be selected to be from 0.0 to about 5% or up to about 15% (as measured according to ASTM D570-98) to create even more delay in the release of the active component.

Polymers with suitable hydrophobicity, which may be used, include homo- and co-polymers of, for example, vinyl acetate, vinyl alcohol, ethylene, acrylic acid, methacrylate, methacrylic acid and others. Suitable hydrophobic copolymers include the following non-limiting examples, vinyl acetate/vinyl alcohol copolymer, ethylene/vinyl alcohol copolymer, ethylene/acrylic acid copolymer, ethylene/methacrylate copolymer, and ethylene/methacrylic acid copolymer.

In some embodiments, the hydrophobic encapsulating material may be present in amounts of from about 0.2% to 10% by weight based on the total weight of the edible composition, including 0.3, 0.5, 0.7, 0.9, 1.0, 1.25, 1.4, 1.7, 1.9, 2.2, 2.45, 2.75, 3.0, 3.5, 4.0, 4.25, 4.8, 5.0, 5.5, 6.0, 6.5, 7.0, 7.25, 7.75, 8.0, 8.3, 8.7, 9.0, 9.25, 9.5, 9.8 and all values and ranges there between, for example, from % to 5% by weight. The amount of the encapsulating material will, of course, depend in part on the amount of the active components used. The amount of the encapsulating material with respect to the weight of the delivery system, is from about 30% to 99%, including 35, 40, 45, 50, 55, 60, 65, 70, 75, 80, 85, 95, 97 and all values and ranges there between, for example, from about 60% to 90% by weight.

In formulating the delivery system, the active components can be entirely encapsulated within the encapsulating material or incompletely encapsulated within the encapsulating material provided the resulting delivery system meets the criteria set forth hereinabove. The incomplete encapsulation can be accomplished by modifying and/or adjusting the manufacturing process to get partial coverage of the active components. In some embodiments, the encapsulation material may form a matrix with the active components.

For example, if ethylene-vinyl acetate is the encapsulating material, the degree of hydrophobicity can be controlled by adjusting the ratio of ethylene and vinyl acetate in the copolymer. The higher the ethylene: vinylacetate ratio, the slower the release of the active component. Using vinyl acetate/ethylene copolymer as an example, the ratio of the vinyl acetate/ethylene in the copolymer can be from about 1 to about 60%, including ratios of 2.5, 5, 7.5, 9, 12, 18, 23, 25, 28, 30, 35, 42, 47, 52, 55, 58.5% and all values and ranges there between.

In a further embodiment, the selection of a delivery system, in addition to or independently from being based on the hydrophobic character of the encapsulating material, can be selected based on the manipulation and selection of the tensile strength of the encapsulating material to provide a delayed and/or controlled release of the active component. Thus, the controlled and/or delayed release of the active component can be controlled by selecting a predetermined tensile strength and/or a predetermined hydrophobicity of the encapsulating material. Such encapsulating materials may be selected from polyvinyl acetate, polyethylene, crosslinked polyvinyl pyrrolidone, polymethylmethacrylate, polylactic acid, polyhydroxyalkanoates, ethylcellulose, polyvinyl acetatephthalate, polyethylene glycol esters, methacrylicacid-co-methylmethacrylate, and the like, and combinations thereof.

As used herein, the term “tensile strength” means the maximum stress a material subjected to a stretching load can withstand without tearing. A standard method for measuring tensile strength of a given substance is defined by the American Society of Testing Materials in method number ASTM-D63 8.

The predetermined tensile strength is determined based, in part, on the active components and the desired release time of the same. The predetermined tensile strength may be selected from a standard comprised of one or more delivery systems with each standard delivery system having a known release rate of the desired active component or combination of components. The delivery system of the present invention may further provides the active components with a protective barrier against moisture and other conditions such as pH changes, reactive compounds and the like, the presence of which can undesirably degrade the active components.

The desired tensile strength of the delivery system can be readily determined within a desired range. In one embodiment of the present invention, the tensile strength of the delivery system is at least 6,500 psi, including 7500, 10,000, 20,000, 30,000, 40,000, 50,000, 60,000, 70,000, 80,000, 90,000, 100,000, 125,000, 135,000, 150,000, 165,000, 175,000, 180,000, 195,000, 200,000 and all ranges and subranges there between, for example a tensile strength range of 6,500 to 200,000 psi,

The formulation of a delivery system with a desirable tensile strength can be made from a variety of encapsulating materials and at least one additive which hereinafter are referred to as “at least one tensile strength modifying agent or modifier.” The at least one additive may be used to formulate the delivery system by modifying the tensile strength of the delivery system, including tensile strength-lowering materials such as fats, emulsifiers, plasticizers (softeners), waxes, low molecular weight polymers, and the like, in addition to tensile strength increasing materials such as high molecular weight polymers. In addition, the tensile strength of the delivery system can also be fine tuned by combining different tensile strength modifiers to form the delivery system. For example, the tensile strength of high molecular weight polymers such as polyvinyl acetate may be reduced when tensile strength lowering agents such as fats and/or oils are added. The presence of fats and oils as an additive has been found to have two effects on the delivery system. The first effect is observed at lower concentrations, i.e. up to 5% by weight, including up to 4.7, up to 4.5, up to 4.25, up to 4.0, up to 3.5, up to 3.0, up to 2.5, up to 2.25, up to 2.0, up to 1.75, up to 1.5, up to 1.0 and all values and ranges there between, wherein the fats and/or oils either maintain or increase the tensile strength of the delivery system. At higher concentrations (i.e., typically above 5% by weight), the fats and/or oils tend to reduce the tensile strength of the delivery system. Even with such unusual or non-linear effects on the tensile strength of the delivery system, a suitable delivery system with the desired release of the active component may be readily formulated in accordance with the present invention because the targeted delivery system is prepared based on sample delivery systems having known release profiles for the active component.

Examples of tensile strength modifiers or modifying agents include, but are not limited to, fats (e.g., hydrogenated or non-hydrogenated vegetable oils, animal fats), waxes (e.g., microcrystalline wax, bees wax), plasticizers/emulsifiers (e.g., mineral oil, fatty acids, mono- and diglycerides, triacetin, glycerin, acetylated monoglycerides, glycerol rosin monostearate esters), low and high molecular weight polymers (e.g., polypropylene glycol, polyethylene glycol, polyisobutylene, polyethylene, polyvinyl acetate) and the like, fillers like talc, dicalcium phosphate, silica, calcium carbonate, and combinations thereof. Plasticizers may also be referred to as softeners.

Thus, by employing tensile strength modifiers, the overall tensile strength of the delivery system can be adjusted or altered in such a way that a preselected tensile strength is obtained for the corresponding desired release profile of the active components from an edible composition based on a comparison with a standard. In one embodiment of the present invention, the encapsulating material is polyvinyl acetate. A representative example of a polyvinyl acetate product suitable for use as an encapsulating material in the present invention is Vinnapas® B100 sold by Wacker Polymer Systems of Adrian, Mich. A delivery system utilizing polyvinyl acetate may be prepared by melting a sufficient amount of polyvinyl acetate at a temperature of about 65° to 120° C. for a short period of time, e.g., 5 minutes. The melt temperature will depend on the type and tensile strength of the polyvinyl acetate encapsulating material where higher tensile strength materials will generally melt at higher temperatures. Once the encapsulating material is melted, a suitable amount of the active components (e.g., high intensity sweeteners such as aspartame and ace K) are added and blended into the molten mass thoroughly for an additional short period of mixing. The resulting mixture is a semi-solid mass, which is then cooled (e.g., at 0° C.) to obtain a solid, and then ground to a U.S. Standard sieve size of from about 30 to 200 (900 to 75 microns). The tensile strength of the resulting delivery system can readily be tested according to ASTM-D638 after molding the encapsulations in required size and shape.

In some embodiments, the delivery system may be in the form of a powder or granules. The particle size, in some embodiments, can vary and not have a significant effect on the function of the present invention. As is discussed herein below, however, the particle size and distribution of particle sizes of the third flavor compositions can have significant effects. In one embodiment, the average particle size is desirably selected according to the desired rate of release and/or mouthfeel (i.e., grittiness) and the type of carrier incorporated in the edible composition. Thus, in certain embodiments of the present invention, the average particle size is from about 75 to about 600 microns, including 100, 110, 140, 170, 200, 230, 260, 290, 320, 350, 370 and all values and ranges therebetween. As the values are an average, one will appreciate within a given sample of powder or granules, there may be particles with sizes greater and/or less than the numerical values provided. In one embodiment of the invention, where the delivery system is incorporated into a chewing gum; the particle size can be less than 600 microns.

In some embodiments, the at least one second flavor composition is a flavor provided as a solid. In some embodiments, the solid form of the at least one second flavor composition is an encapsulated flavor in an amount of from about 1.0% to about 5.0% w/w based on the weight of the chewing gum composition. As used herein, the term “encapsulated” refers to flavor(s) and flavor delivery systems that provide an delayed release. As used herein, the term “delayed release” refers to flavor(s) and flavor delivery systems that provide flavor release during the intermediate or later chew in time frames from about 30 seconds or more. In some embodiments, the at least one second flavor is a solid flavor in amount of not more than 6.0% w/w by weight of the chewing gum while in other embodiments, the amount of the at least one second flavor in solid form is in an amount of not more than 4.5% w/w by weight of the chewing gum composition. In a preferred embodiment, the at least one second flavor in solid form is in an amount of not more than 4.0% w/w by weight of the chewing gum composition. In some embodiments, the at least one second flavor can be a combination of dry forms. In some embodiments, the dry forms can include, but are not limited to, those described in WO 2008/027251, the relevant disclosure of which is incorporated herein by reference. Particles formed from a flavor compounded with binders or other agents. The particles will typically range in size fro111 about 200 to about 850 microns, preferably between about 400 and 700 microns. Various types of compounded flavors may be used and prepared by various techniques known in the art. Some of these include extrusion or co-extrusion, spray cooling or spray chilling, co-aeration, fluid bed coating, or granulation or agglomeration. These methods can be used to make powdered flavors. Agglomeration methods can be used to increase the size of the particles. This can be done by agglomeration by recrystallization, by use of film forming binders, and by layering. These various types of products are offered by the various flavor suppliers such as EVOGRAN® from Symrise, INSTANTIFF® by International Flavors & Fragrances, or ULTRASEAL® or GRANUSEAL® by Givaudan. Examples of extended matrixes are DURAORME® and FELXAROME® from Firmenich and Cap Lock from International Flavors and Fragrances. A particularly useful type of particle including a compounded flavor is called Q-PEARLS® and is available from Quest. This material contains flavors that are made by agglomerated layers. The particle size of the QPEARLS may range between 200 microns and 850 microns, with about half of the particles between 400 and 700 microns.

In some embodiments, the carrier for the at least one second flavor can be a carbohydrate such as sugars, polyols, or combinations. In some embodiments, the carrier for the at least one second flavor can be a food acid such as malic acid, citric acid, lactic acid, tartaric acid, or combinations thereof. In some embodiments, the food acid carrier of the at least one second flavor can be in an amount of from about 20% -60% w/w by weight of the at least one second flavor. In a preferred embodiment, the food acid carrier can be in an amount of 25-40% w/w by weight of the at least one second flavor while in a particularly preferred embodiment, the food acid carrier can be in an amount of 25% -30% w/w by weight of the at least one second flavor.

In one aspect of the invention, the at least one third flavor composition releases after the second flavor composition begins to release.

In another aspect of the invention, the at least one third flavor composition reaches at least one third peak flavor intensity after the at least one second flavor composition reaches the at least one second peak flavor intensity.

In another aspect of the invention, the at least one third flavor composition begin to release when the at least one second flavor composition has released for at 15 to 40 seconds, including 60, 70, 80, 90, 95 seconds and all values and ranges there between.

In another aspect of the invention, the at least one third flavor composition begins to release when the at least one second flavor composition has reached at least from 50 to 100% of the at least one peak flavor intensity, including 60, 70, 80, 90, 95% and all values and ranges there between.

In another aspect of the invention, the at least one third flavor composition begins to release when at least about 50% of the at least one first second composition has released from the chewing gum composition, including at least 60, 70, 75, 80, 90, 95, 97%, and all values and ranges there between.

In another aspect of the invention, at least one third flavor composition reaches a third peak flavor intensity after the at least one second flavor composition reaches the second peak flavor intensity. So, for example, if the peak flavor intensity of the second flavor composition reaches its peak at 45 seconds, the third flavor composition shall release the flavor at about 60 to 90 seconds reaching its peak flavor intensity from about 90 to about 200 seconds, such as 100 and 30 to 45, including all values and ranges there between, after mastication, t=0 seconds. In a particularly preferred embodiment, the third flavor composition shall control release or delay release of the flavor embodied therein for a period of time up to about 15 minutes, including 20 minutes, 25 minutes, 30 minutes, 35 minutes, 40 minutes or more, as well as all values and ranges there between.

In one embodiment, the third flavor composition comprises a delivery system that is the same as the second flavor composition but is adjusted to deliver the flavor contained therein to reach a peak flavor intensity as described herein. In a preferred embodiment, the third flavor composition comprises a delivery system that is different from the second flavor composition. The at least one third flavor composition is preferably in the form where the flavors are provided in one or more delivery systems based on the selection of encapsulating, polymeric materials having specified hydrophobicity and/or such that the delivery system has a certain tensile strength or range thereof, optionally including tensile strength modifying agents, to control and/or delay release of the flavor in the period of time discussed herein above. In one embodiment, the delivery system is as described in US PG publications 2007/0298061, 2006/0263480, 2006/0263479, 2006/0263478, 2006/0263477, 2006/0263473, 2006/0263472, 2006/0263413, 2006/0193896, 2006/0034897, 2005/0220867, 2005/0214348, and/or 2005/0112236, the relevant disclosures for which are incorporated herein by reference.

In a particularly preferred embodiment of the third flavor composition, the composition is a particulate contained in a delivery system and having a particle size of 425 to 1000 μm, preferably from 600 to 850 μm, including all values and ranges there between, e.g., 475, 550, 625, 650, 675, 700, 725, 750, 775, 825, 875, 900, 925, 950, 975. In further preferred embodiments, the delivery system has at least 80%, preferably 100% of the particles below 1000 μm, preferably 850 μm. Without being limited to theory, the inventors believe that by minimizing and/or eliminating the large particles, bitterness can be avoided or attenuated associated with the flavor(s), e.g., mint, provided with the third flavor composition. In further preferred embodiments, the delivery system has at least 80%, preferably 100% of the particles above 425 μm, preferably 600 μm. Without being limited to theory, the inventors believe that by minimizing and/or eliminating the small particles, a good balance flavor release and reducing the propensity for early flavor release from the delivery system is achieved.

In another preferred embodiment, combined or separate from other embodiments for the at: least one third flavor composition, a delivery system as described in US. 2007/274930 can be used, the relevant disclosure for which is incorporated herein by reference. In this embodiment, a particulate composition comprising controlled release particles wherein discrete elements of flavoring-containing fat are dispersed in a gelatin matrix, said particles containing: 0.1-40 wt %, preferably 5-30 wt % of flavoring; 10-70 wt %, preferably 20-50 wt % of gelatin; and 0.1-75 wt %, preferably 5-50 wt % of fat having a melting point of at least 35OC, said particles having a volume weighted average diameter of 50-1500 μm. The term “volume weighted average diameter” refers to the volume based average diameter of the particles, which can suitably be determined using a Beckman Coulter LS Particle Size Analyzer or by employing a conventional sieving method. The encapsulation composition according to the invention, comprising gelatin and as defined herein before, may be used advantageously to encapsulate volatile or labile flavoring components which may be in liquid or in solid form, and which are typically insoluble in water.

The particulate composition is particularly suited for providing a controlled release of menthol, mint and/or eucalyptus flavor in chewing gum applications. Gelatin of any type and grade may suitably be used, including for example gelatin derived from bone or skin, preferably from bone. Modified gelatins including e.g. gelatin meta phosphates, hardened gelatin (e.g. those treated with a cross-linking agent such as formaldehyde), heat-treated gelatins and others may also be employed. The Bloom strength of the gelatin that is used may vary widely and may suitably range from 0-300, especially 10-300. The degree to which the release of the flavoring composition from the matrix is delayed is partly determined by the Bloom or gelling strength of the gelatin. When a relatively fast release of the flavoring from the matrix upon consumption is desired, it is preferred to use a gelatin having a Bloom less than 150, more preferably less than 100. When a slow release of the flavoring upon consumption is desired the Bloom will preferably be at least 150, more preferably at least 200, most preferably at least 240. Gelatins having relatively high Bloom strength have a tendency to give hard, “crunchy” textures which may not be desirable in the manufacture and consumption of chewing gums. In cases where the texture of the end product is not particularly critical even higher Bloom strengths than the ones disclosed here may suitably be used. It may be clear to the skilled person that by using hardened gelatin the occurrence of the flavor release peak may be delayed as well, compared to non-hardened gelatin.

The term “fat” as used in the context of these particulate systems encompasses triglycerides, sucrose polyesters of fatty acids and combinations thereof. High melting fat may be obtained by hydrogenation of vegetable oils and/or animal fats, or by isolating high melting fractions from these oils and fats. The fat contained in the particles may have a melting point of at least 35OC., more preferably of at least 3 g° C., most preferably of at least 45′C.

Typically at least 90%, more preferably at least 95% of the flavoring is dissolved or dispersed homogeneously in the discrete fat elements. Typically, the mass weighted mean diameter of the discrete flavoring-containing fat elements will be in the range of 0.5-10 μm, preferably in the range of 0.8-3 μm.

The amount of fat that is comprised in the particles may vary between 0.1 and 75 wt %, depending on the ‘release-characteristics’ that are desired. In order to provide a relatively slow release, the amount of fat contained in the particles preferably is at least 5 wt %. In case an even slower release is desired, e.g. in chewing gum applications, the amount of fat preferably exceeds 8 wt %, even more preferably it exceeds 10 wt %. It is furthermore preferred that the amount of fat does not exceed 65 wt %, more preferably it does not exceed 50 wt %.

The gelatin can be present in an amount of 10-70 wt %. The delay in the occurrence of the flavor release peak, e.g. during mastication, is, amongst others, dependent on the relative amounts of gelatin and fat comprised in the matrix.

The particles can comprise 0.1-40 wt % of flavoring, including at least 0.5 wt %, more preferably at least 2 wt % and most preferably at least 5 wt % of flavoring.

The particulate flavoring composition can also comprise a film forming carbohydrate. The film forming carbohydrate is suitably selected from the group consisting of gums, modified starches, cellulose derivatives and mixtures thereof. Preferably, the film forming carbohydrate is selected from gums, modified starches and mixtures thereof. Particularly preferred but non-limiting examples of film forming carbohydrates are selected from the group of gums, such as gum Arabic or gum acacia, modified starches, cellulose derivatives, such as methylcellulose, ethylcellulose, hydroxyethyl cellulose, hydroxypropyl cellulose, hydroxypropyl methyl cellulose, carboxymethyl cellulose and mixtures thereof. The film forming carbohydrate may be comprised in the particles in an amount of 0.1-10 wt %, preferably 2-6 wt %.

The particulate flavoring composition may further comprise a carbohydrate plugging material. With the term ‘plugging material’, as used herein, a material is meant that is used to modify in particular the glass transition temperature and the melting behavior of the particle matrix, thereby providing an improved oxygen barrier to the encapsulated flavor and preventing flavor from leaking out of the encapsulate. The plugging material may suitably be selected from the group of mono, di and tri-saccharides, such as for example glucose, fructose, maltose, sucrose, raffinose, xylitol, sorbitol and mixtures thereof. These saccharides may also be provided in the form of materials having a high content of such sugars, such as fruit juice solids. Preferably, the plugging material is selected from maltose, sucrose, xylitol, sorbitol and combinations thereof. Even more preferably, in the instance where the flavoring composition is intended to be used in so-called ‘sugar-free chewing-gum’, the plugging material is selected from xylitol, sorbitol and combinations thereof. Plugging material is typically comprised in the particles of the present particulate composition in an amount ranging from 1-30 wt %, preferably 10-20 wt %.

The bulk density of the particulate composition is typically within the range of 300-700 dl. Preferably the bulk density is within the range of 400-600 dl. Typically, the composition comprises 0-6 wt % of water, especially 0.3-4 wt % of water.

The controlled release particles present in the particulate composition may optionally comprise additional food-grade additives known in the art. Typical examples comprise artificial sweeteners, preservatives, colorants, fillers, and the like. The particulate composition may contain other particulate material, such as sugar, coloring and the like.

The particulate compositions according to the present invention are typically obtained by drying emulsions comprising gelatin, fat, flavoring, and optionally a film forming carbohydrate, a plugger substance or any other desired additive, by any conventional process known in the art, such as spray-drying, drum drying, extrusion, fluidized bed processing or freeze drying. Preferably the emulsion is dried by fluidized bed processing or freeze drying. The freeze drying process is typically carried out by solidifying said emulsion in a workable shape, e.g. into 1 cm beads using a palletizing unit. The beads are then collected and subjected to a standard freeze drying process.

The emulsion for use in the drying process as mentioned above is preferably obtained by preparing an aqueous solution of the water-soluble components, which include the gelatin and optionally the plugger material and the film forming carbohydrate; and then adding thereto a mixture of the flavoring and the fat, which mixture may suitably have been prepared by dispersing the flavoring into the molten fat. The emulsion is suitably homogenized while being kept at a temperature above the melting point of the fat. The size of the fat droplets is closely monitored during homogenization since, as mentioned before, the size and quantity of the discrete fat elements in the end-product particle affect the release characteristics of the flavor upon consumption. When the fat droplets in the emulsion have the desired size, the emulsion is subjected to a drying step.

The particulates comprised of gelatin, fats, and the like may be further coated with e.g. long chain hydrocolloid, such as but not limited to those selected from the group of polysaccharides, zein, shellac, cellulose derivatives and mixtures thereof. Particularly advantageous results can be obtained if the coating layer represents from 0.5-5 wt. % of the coated particles.

In some embodiments, the at least one third flavor composition is a flavor provided as a solid. In some embodiments, the solid form of the at least one third flavor composition is an encapsulated flavor in an amount of from about 1.0% to about 4.0% w/w by weight of the chewing gum composition. In some embodiments, the at least one third flavor is a solid flavor in amount of not more than 4.5% w/w by weight of the chewing gum while in other embodiments, the amount of the at least one third flavor in solid form is in an amount of not more than 4.0% w/w by weight of the chewing gum composition. In a preferred embodiment, the at least one third flavor in solid form is in an amount of not more than 3.5% w/w by weight of the chewing gum composition.

In some embodiments, the at least one third flavor is a mint flavor which can include mint oils such as peppermint oils, spearmint oils, and the like. In some embodiments, the at least one third flavor is a mint flavor which can include mint oils and other flavor components such as cooling compounds such as those described below.

In some embodiments, the at least one third flavor is a solid form with flavor(s) in amounts of from about 3% to about 8% w/w by weight of the at least one solid third flavor. In a preferred embodiment, the at least one solid third flavor has an amount of flavor of from 4%-7% w/w by weight of the at least one solid third flavor and in a particularly preferred embodiment, the at least one solid third flavor has an amount of flavor of from 5%-6%.

In some embodiments, the amount of flavor included in the at least one third flavor in solid form can be changed to effect the release profile of the at least one third flavor. For example, in embodiments where a higher intensity mint flavor is desired after 20-30 minutes of chewing, an at least one third flavor in solid form can include a higher amount of flavor such as an amount of from about 5% -about 8% w/w by weight of the at least one third flavor in solid form. In other embodiments where a blended fruit-mint or even a more predominant hit flavor intensity is desired after 20-30 minutes of chewing, an at least one third flavor in solid form can include a lower amount of flavor such as an amount of from about 3% -about 4% w/w by weight of the at least one third flavor in solid form. In some embodiments, the type of flavor included in the at least one third flavor can be changed to effect the release profile of the at least one third flavor. For example, in embodiments where a higher intensity mint flavor is desired after 20-30 minutes of chewing, an at least one third flavor in solid form can include cooling compounds and peppermint oils. In other embodiments where a blended hit-mint or even a more predominant hit flavor intensity is desired after 20-30 minutes of chewing, an at least one third flavor in solid form can include a lower amount of cooling compounds and spearmint oil

In one embodiment, polyvinyl acetate (PVAc) containing a nanoclay delivery system can be used to encapsulate flavors, preferably flavor emulsions, to release the flavor for a period of from 1 to 5 minutes, 5 to 10 minutes or more than 10 minutes when that delivery system is contained within a chewing gum and that chewing gum is consumed. Examples of suitable nanoclays include the organo clays produced by Southern Clay Inc, Claytone, Garamite, Perchem, Laponite, Gelwhite, Mineral Colloid, Bentonite, and Peromont.

Molten or dissolved PVAc containing nano clays (1-20% by weight) is co-extruded with a flavor core into a water bath. The strength of the microcapsule is adjusted to give the desired release profile in chewing gum. For immediate release cross linked gelatin or alginate can be used. To delay the release to between 1-5 min low molecular weight PVAc (2000-14000) can be used. To delay the release between 5-10 minutes medium molecular weight PVAc (30,000-80,000) can be used. To delay the beyond 10 min, PVAc with a higher molecular weight (100,000-500,000) can be used. The release profile can also be modified by changing the particle size of the microcapsules within the given polymer system. For example, smaller particle give faster release while larger microcapsules give somewhat delayed release.

In another embodiment, the at least one third flavor composition is defined having substantially little to no water content, including less than lo%, less than 7%, less than 5%.

In one embodiment, the chewing gum composition includes a hydrocolloid. While incorporating alginates into chewing gums had been described, e.g., in U.S. Pat. No. 6,238,711, it was reported to use very low levels, i.e., not exceeding 1% by weight. These levels, however, were insufficient for the format of chewing gum compositions described in the present application. Therefore in embodiments where hydrocolloids, such as alginates are used, the hydrocolloid is present in an amount of from 1.5 to 20% by weight of the chewing gum composition, including 2, 3, 4, 5, 6, 7, 8, 9, 10, 11, 12, 1,3, 14, 15, 16, 17, 18, 19% and all values and ranges there between. For example, ranges of from 1.5% -10.0%, 3-7.5%, and 1-5-3% can be useful in the context of the present invention.

Hydrocolloids are known in the art. Representative examples of hydrocolloids useful in the context of the present invention include sodium alginate, propylene glycol alginate, carrageenans, agar, starches, modified starches, gelatin, xanthan gum, gellan gum, gum Arabic, pectins, proteins, celluloses, modified celluloses, chitosan, inulin, Konjac. The hydrocolloids can be used alone or in a combination of two or more of these.

Examples of Hydrocolloids and ranges of amounts include Sodium Alginate (low viscosity) in an amount of from 2.0-7.5% or 1.5-3%; Sodium Alginate (medium to high molecular weight) in an amount of 2.0% and 5.5%; Propylene glycol alginate in combination with sodium alginate; Carrageenan, Cellulose, Pullulan, Xanthan gum; and/or Hydroxyl propyl methyl cellulose in an amount of about 3% (but greater than 0); Guar gum in an amount of 1.0-5.5%; Agar, Gum Arabic, and/or Pectin in an amount not greater than 5.5% is to high (but greater than 0); Carboxymethyl cellulose Konjac; Gellan gum; and Gelatin.

In certain preferable embodiments, alginates with low, medium and high viscosities singly or in combination are used as the hydrocolloids. There are major two commercial alginates, sodium alginate (Manucol B series) and propylene glycol alginate (Kelcoloid B series). There are different molecular weight and particle size of alginates with different chemistry (sodium and propylene glycol alginates). Other alginates with different molecular weights, chemical modifications, and particle sizes commercially available alginates include Manucol B LV, MV, HV; Kelcoloid B HVF; and Kelcoloid B LVF. It is known in the art that low viscosity alginates have a molecular weight in the range of 12,000 to 80,000 with a degree of polymerization in the range of 60 to 400; medium viscosity alginates have a molecular weight in the range of 80,000 to 120,000 with a degree of polymerization in the range of 400-600 and high viscosity alginates have a molecular weight in the range of 120,000 to 190,000 with a degree of polymerization in the range of 600 to 1000.

The hydrocolloids can be added as dry or substantially dry powders to the chewing gum composition during its compounding and mixing. Also, hydrocolloids can be dissolved into solution and form a slurry. The slurry can include flavors, sensate ingredients, sweeteners, functional ingredients, and the like. In some embodiments, the slurry can be subsequently dried and form a film. The film can be added directly into the gum formulation or be ground into smaller particles (10-500 microns) and then applied into the gum matrix.

In certain aspects, in some embodiments, the chewing gum composition can be flavored with only encapsulated flavor(s) and without any liquid flavor(s). However, in such compositions, the composition faces problems such as hardness (reducing its suitability for commercial work-up) and the consumer chewing experience is insufficient as the gum has hard texture and causes discomfort during mastication. Also, flavor release is minimized resulting to a weak flavor perception.

Even by adding typical softeners, such as glycerin can overcome these two problems, in part, by softening the gum matrix. However, the glycerin will release from chewing gum in 15 seconds mastication, leaving hard gum texture leaving an unpleasant and hard chewing gum wad. Adding one or more hydrocolloids as described herein can improve these problems. Generally, hydrocolloids, such as alginates absorb water quickly, which makes them useful as additives in dehydrated products. A chewing gum containing hydrocolloid (e.g., sodium alginate or propylene glycol alginate) has a softer texture because the hydrocolloid swells in the presence of saliva. As a result, the density of chewing gum has a softer chew texture.

An additional advantage of using hydrocolloids in the context of the present invention in that including one or more hydrocolloids in the chewing gum composition to soften the gum base and its texture does not reduce or delay release of the sweetener and/or flavor components in the way that typical softeners, such as fats and waxes, have been found to effect the release of those components during mastication. For example, using alginates as an example of the hydrocolloid, the addition of alginates can soften the chewing gum composition and in certain instances improve flavor release during the chew. The choice of alginates can affect the extent and timing of the softening of the gum and flavor release. For example, alginates with high molecular weight may delay the softening affect and improved flavor release until later in the chew, while lower molecular weight alginates may have affects at the beginning of the chew.

In some instances, the hydrocolloid(s) may be released from the gum matrix and dissolved quickly. Also, because hydrocolloids can be hygroscopic in some embodiments, shelf stability may be an issue. Therefore, in one aspect of the present invention, the hydrocolloid(s) is/are combined with a encapsulating and/or coating material.

Powder or granule hydrocolloids can be spray-coated using fat and wax to achieve core-shell encapsulates to reduce and/or eliminate the undesired interaction of the hydrocolloid with moisture. Other polymers with low hydrophilicity, such as polyvinyl acetates can be used as the spray coating material. In yet other embodiments, the hydrocolloids can be encapsulated in one or more delivery systems based on the selection of encapsulating, polymeric materials having specified hydrophobicity and/or such that the delivery system has a certain tensile strength or range thereof, optionally including tensile strength modifying agents, in a manner similar to that described hereinabove for sweeteners and/or flavors. Disclosures for preparing polymeric encapsulations are detailed above and described in US PC publications 2007/0298061, 2006/0263480, 2006/0263479, 2006/0263478, 2006/0263477, 2006/0263473, 200610263472, 2006/0263413, 2006/0193896, 2006/0034897, 200510220867, 2005/0214348, and/or 2005101 12236, the relevant disclosures for which are incorporated herein by reference. Combinations of different hydrocolloids and/or two or more encapsulations of hydrocolloids providing different release profiles of the hydrocolloids can be used. The end goal is to provide a consistent softer/smoother chew texture during the course of the chewing time.

In certain aspects of the present invention, some or a part of the flavor used in the flavor compositions can include liquid flavor. If the liquid flavor is used in low quantities, e.g., from about 0.05 to 4%, the gum matrix can become dry and hard to chew, significantly reducing the consumers perception of the product. Therefore, in embodiments where low levels of liquid flavor is used in the, e.g., first, second or third flavor compositions, in one preferred aspect of the invention, one or more hydrocolloids, e.g., sodium alginate is used in amounts above or, e.g., in amounts greater than 1% w/w and up to about 8% w/w, including 2, 2.5, 3, 3.5, 4, 4.5, 5, 5.5, 6, 6.6, 7, 7.5 and all values and ranges there between.

In some embodiments, the hydrocolloid can be provided crosslinked, and preferably if provided crosslinked, the crosslinked hydrocolloid at least partially encapsulates one or more flavors in the one or more flavor compositions described herein, e.g., the first, second and/or third flavor compositions with the at least one second flavor composition being preferred. If the hydrocolloid is used as an encapsulation then it may be used in place of or in combination with the polymeric systems described herein above for the flavor compositions. Preferably the hydrocolloid used in this embodiment is an alginate.

Alginates, such as sodium alginate, propylene glycol alginate, and the like, are hydrocolloids that are water soluble. When they interact with a cation, such as ca2⁺, they can be cross-linked and form a rigid and robust matrix. (See, e.g., WO 2004/098318, the relevant disclosure of which is incorporated herein by reference). Compared to other hydrocolloids, the advantage of using alginate is that they are water soluble and the viscosity in the solution form is relatively low. This allows less equipment and processing requirements for each of the unit operations. Also, the cross-linking process is very fast (usually within 10 sec for fully cross-linked material) and the process is simple.

Sodium alginate can be dispersed into water and allow it fully hydrate, e.g., for about 15 minutes. The surfactant and optionally an emulsifier can be added followed by the flavors, if added. This composition can be mixed until homogeneous whereby it is dried (e.g., under vacuum) and/or cast on a surface to dry into thin film. The thickness is controllable and can be determined by the final particle size of the encapsulates. After the drying, the film can be ground into certain particle size (e.g., about 200-350 micron). The crosslinked composition can be used directly or placed in a Ca Cl₂ solution with stirring for a short period of time (e.g., 2 minutes), followed by rinsing and air-drying.

The cross-linked alginate (with and without further polymeric encapsulation) can be used for other ingredients such as lipophilic ingredients, sweeteners, active ingredients, sensate and sensate blends, and the like.

The cross-linked alginate structures containing one or more flavors, sweeteners and/or other actives can be further encapsulated in one or more delivery systems based on the selection of encapsulating, polymeric materials having specified hydrophobicity and/or such that the delivery system has a certain tensile strength or range thereof, optionally including tensile strength modifying agents, as described hereinabove, e.g., see US PG PUBS 2007/0298061, 2006/0263480, 2006/0263479, 2006/0263478,2006/0263477, 2006/0263473, 2006/0263472, 2006/0263413, 2006/0193896, 2006/0034897, 2005/0220867, 2005/0214348, and/or 2005/0112236, the relevant disclosures for which are incorporated herein by reference.

Flavorants, which may be used, include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Non-limiting representative flavor oils include spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, and fruit essences including apple, pear, peach, grape, blueberry, strawberry, raspberry, cherry, plum, pineapple, apricot and so forth. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

Cooling agents can include, for example, menthol, N-ethyl-p-menthane-3-carboxamide (WS-3), the ethyl ester of N-[[S-methyl-2-(1-methylethyl)cyclohexyl]carbonyl]glycine (ethyl 3-(p-menthane-3-carboxamido)acetate; WS-5), N-(4-methoxyphenyl)-p-menthan-3-carboxamid(WS-12), N-tert-butyl-p-menthan-3-carboxamide (WS-14), menthane carboxy esters such as WS-4 and WS-30, N-ethyl-2,2-diisopropylbutanamide,N-(I,1-dimethyl-2-hydroxyethyl)-2,2-diethylbutanamide, isopulegol, 3-(L-menthoxy)propane-1,2-diol,3-(L-menthoxy)-2-methylpropane-1,2-diol, menthane diols such as p-menthane-2,3-diol and p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexane carboxamide, Japanese mint oil, peppermint oil, menthone, isomenthone, menthone glycerol ketals, menthyl lactate, 3-(L-menthoxy)ethan-1-01, 3-(L-menthoxy)propan-1-01, 3-(L-menthoxy)butan-1-01, L-menthyl acetic acid N-ethyl amide, L-menthyl-4-hydroxypentanoate, L-menthyl-3-hydroxybutyrate,N,2,3-trimethyl-2-(1-methylethyl)-butanamide, N-ethyl-trans-2-cis-6-nonadienamide, N,N-dimethyl menthyl succinamide, menthyl pyrrolidone carboxylate, xylitol, erythritol, menthane, menthone ketals, substituted p-menthanes, acyclic carboxamides, monomenthyl glutarate, substituted cyclohexanamides, substituted cyclohexane carboxamides, substituted menthanols, hydroxyrnethyl derivatives of p-menthane, 2-mercapto-cyclodecanone, 2-isopropyl-5-methylcyclohexanol, cyclohexanamides, menthyl acetate, menthyl salicylate, N,2,3-trimethyl-2-isopropylbutanamide (WS-23), icilin, camphor, borneol, eucalyptus oil, peppermint oil, bornyl acetate, lavender oil, wasabi extracts, horseradish extracts, 3,1-menthoxypropane 1,2-diol, and the like, and combinations thereof. These and other suitable cooling agents are further described in, for example, U.S. Pat. Nos. 4,032,661 and 4,230,688 of Rowsell et al., U.S. Pat. No. 4,459,425 to Arnano et al., U.S. Pat. No. 4,136,163 to Watson et al., U.S. Pat. No. 5,266,592 to Grub et al., and U.S. Pat. No. 6,627,233 to Wolf et al. In some embodiments, the cooling agent is selected from the group consisting of menthol, N-ethyl-p-menthane-3-carboxamide (WS-3), the ethyl ester of N-[[5-methyl-2-(I-methylethyl)cyclohexyl]carbonyl]glycine, N-ethyl-2,2-diisopropylbutanamide, -N-(1,I ditmethyl-2-hydroxyethyl)-2,2-diethylbutanamide,N-(2-hydroxyethyl)-2-isopropyl-2,3-dimethyl butanamide, N-(3-ethoxypropyl)-2-isopropyl-2,3-dimethyl butanamide, N-(3-propoxypropyl)-2-isopropyl-2,3-dimethylbutanamide, N-(3-butoxypropyl)-2-isopropyl-2,3-diinethylbutanamide, N-p-benzene acetonitrile menthane carboxamide, N-(4-cyanomethylphenyl)-p-menthane carboxamide, (also known as FEMA GRAS 4496, N-(4-cyanomethylphenyl) p-menthane carboxamide and as disclosed in U.S. Pat. No. 7,414,152), isomers of cyclohexane carboxamides such as the neo-isomer of N-(4-cyanomethylphenyl) p-menthane carboxamide as described in W02010019730, N,2,3-trimethyl-2-isopropyl butanamide (WS-23), menthyl glutarate, menthyl lactate, menthyl succinate, and combinations thereof. In other embodiments, the cooling agent is selected from the group consisting of N-ethyl-p-menthane-3-carboxamide (WS-3), N,2,3-trimethyl-2-isopropyl butanamide (WS-23), menthyl glutarate, menthyl lactate, menthyl succinate, N-(4-cyanomethylphenyl) p-menthane carboxamide, and combinations thereof.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. This may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus hits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, blueberry, blackberry, strawberry shortcake, and mixtures thereof.

The sweeteners used may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include: (a) water-soluble sweetening agents such as dihydrochalcones, monellin, steviosides, glycyrrhizin, dihydroflavenol, and sugar alcohols such as sorbitol, mannitol, maltitol, and L-aminodicarboxylic acid aminoalkenoic acid ester amides, such as those disclosed in U.S. Pat. No. 4,619,834, which disclosure is incorporated herein by reference, and mixtures thereof; (b) water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-I<), the free acid form of saccharin, and mixtures thereof; (c) dipeptide based sweeteners, such as L-aspartic acid derived sweeteners, such as L-aspartyl-L-phenylalanine methyl ester (Aspartame) and materials described in U.S. Pat. No. 3,492,131, L-alpha aspartyl-N-(2,2,4,4-tetramethyl-3-thietanyl)-D-alaninamide hydrate (Alitame), methyl esters of L-aspartyl-L-phenyl glycerine and L-aspartyl-L-2,5-dihydrophenyl-glycine, L-aspartyl-2,5-dihydro-L-phenylalanine; L-aspartyl-L-(1-cyclohexen)-alanine, neotame, and mixtures thereof; (d) water-soluble sweeteners derived from naturally occurring water-soluble sweeteners, such as components derived from stevia such as, but not limited to, steviol glycosides, stevioside, rebaudiosides, rebaudioside A, rebaudioside, rebaudioside C, dulcoside, and combinations, lo han quo, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofiranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro-1′,6′-dideoxysucrose; 4-chloro-4-deoxy-alpha-D-galactopyranosy-1,6-dichloro-1,6-dideoxy-beta-D-fi-uctofuranoside, or 4,11,6′-trichloro-4, 1′,6′-trideoxygalactosucrose; 4,6-dicliloro-4,6-dideoxy-alpha-D-galactopyanosyl-6-chloro-6-deoxy-beta-D-fructofiranoside, or 4,6,6′-trichloro-4,6,6′-trideoxygalactosucrose;6,1f,6′-trichloro-6,1′,6′-trideoxysucrose; 4,6-dichloro-4,6-dideoxy-alpha-D-galacto-p-mosyl-1,6-dichloro-1,6-dideoxy-beta-D-fructofuranoside, or 4,6,1′,6′-tetrachloro-4,6,1′,6′-tetradeoxygalacto-sucrose; and 4,6,11,6′-tetradeoxy-sucrose, and mixtures thereof; (e) protein based sweeteners such as thaumaoccous danielli (Thaumatin I and 11), talin, and (f) amino acid based sweeteners.

The intense sweetening agents may be used in many distinct physical forms well-known in the art to provide an initial burst of sweetness and/or a prolonged sensation of sweetness. Without being limited thereto, such physical forms include free forms; such as spray dried, powdered, beaded forms, encapsulated forms, and mixtures thereof. In one embodiment, the sweetener is a high intensity sweetener such as aspartame, sucralose, steviosides, rebaudiosides, lo han quo, monatin, and acesulfame potassium (Ace-K).

The sweetener(s) and/or flavorant(s) may be used in amounts necessary to impart the desired effect associated with its use (e.g., sweetness, flavor intensity). The sweetener(s) and/or flavorant(s) may be present in amounts of from about 1% to 70% by weight based on the total weight of the composition, including 5, 10, 15, 20, 25, 30, 35, 40, 45, 50, 55, 60, 65% by weight, and all values and ranges there between, for example, from about 10% to 40% by weight based on the total weight of the delivery system. For typical edible compositions including chewing gum compositions, the sweeteners may be present in amounts of from about 0.1% to 6% by weight based on the total weight of the edible composition, including 0.5, 1, 2, 3, 4, 5% by weight and all values and subranges there between, for example, 0.5% to 3% by weight.

In one preferred aspect of the invention at least one first flavor composition includes at least one a fruit flavor.

In one preferred aspect of the invention at least one second flavor composition comprises a fruit flavor and a mint flavor.

In one preferred aspect of the invention at least one third flavor composition comprises a mint flavor.

In one preferred aspect of the invention the at least one first flavor composition is a flavor provided as a liquid, e.g., a liquid flavor. In one preferred aspect of the invention where a liquid flavor is used, for example, in the at least one first flavor composition, the amount of liquid flavor is limited to not more than about 1% w/w based on the weight of the first flavor composition, including not more than 0.7% w/w, not more than 0.5% w/w, not more than 0.4% w/w, not more than 0.2% w/w, as well as all values and ranges there between.

The sweetener(s) may also be present in the composition in free form.

Gum Base and Manufacturing Chewing Gum

The present invention may be incorporated with a variety of processes for preparing chewing gum compositions as known in the art. Such chewing gum compositions may be and include a variety of different formulations that are typically used to make chewing gum products. Typically, a chewing gum composition contains a chewable gum base portion, which is essentially free of water and is water insoluble and a water soluble bulk portion.

The water soluble portion is generally released from the gum base portion over a period of time during chewing. The gum base portion is retained in the mouth throughout the chewing. The water insoluble gum base generally comprises elastomers, elastomer solvents, plasticizers, waxes, emulsifiers, and inorganic fillers. Plastic polymers such as polyvinyl acetate, which behave somewhat as plasticizers, are also included. Other plastic polymers that may be used include polyvinyl laurate, crosslinked polyvinyl pyrrolidone and polyhydroxy alkanoates.

The elastomers may constitute from about 5% to 95% by weight of the gum base, for example about 7% by weight. In another embodiment, the elastomers may constitute from about 10% to 70% by weight of the gum base and in another embodiment, 15% to 45% by weight of the gum base. Examples of elastomers include synthetic elastomers such as polyisobutylene, polybutylene, isobutylene-isoprene co-polymers, styrene-butadiene co-polymers, polyvinyl acetate, butyl rubber and the like. Elastomers may also include natural elastomers such as natural rubber as well as natural gums such as jelutong, lechi caspi, perillo, massaranduba balata, chicle, gutta hang kang or combinations thereof. Other elastomers are known to those of ordinary skill in the art.

Synthetic elastomers can include materials of varying molecular weights that provide different characteristics to the chewing gum. Using elastomers with different molecular weights can influence the chew texture and flavor release of the chewing gum. In chewing gum systems with relatively low levels of liquid flavor (for example where the amount of liquid flavor is 1.5% w/w by weight of the chewing gum composition or less, lower molecular weight elastomers can help provide for a softer chew texture. In some embodiments, suitable lower molecular weight elastomers can include, but are not limited to, polyisobutylene with molecular weights of from about 40,000 gm/mol to about 100,000 gm/mol. In other embodiments, suitable lower molecular weight elastomers can include, but are not limited to, polyvinyl acetate with molecular weights of from about 4,000 Daltons to about 20,000 g/mol with still other embodiments where the polyvinyl acetate has a molecular weight of from about 12,000 to about 18,000 gm/mol.

Elastomer plasticizers modify the finished gum firmness when used in the gum base. Elastomer plasticizers are typically present in an amount up to 75% by weight of the gum base. In another embodiment, the elastomer plasticizers are present in an amount of from about 5% to 45% by weight of the gum base and in another embodiment from about 10% to 30% by weight of gum base. Examples of elastomer plasticizers include natural rosin esters such as glycerol ester of partially hydrogenated rosin, glycerol ester of tall oil rosin, pentaerythritol esters of partially hydrogenated rosin, methyl and partially hydrogenated methyl esters of rosin, and the like. Synthetic elastomer plasticizers such as terpene resins may also be employed in gum base composition.

Waxes include synthetic and naturally occurring waxes such as polyethylene, bee's wax, carnauba and the like. Petroleum waxes such a paraffin may also be used. The waxes may be present in the amount up to 30% by weight of the gum base. Waxes aid in the curing of the finished gum and help improve the release of flavor and may further extend the shelf life of the product.

Elastomer solvents are often resins such as terpene resins. Plasticizers, sometimes referred to as softeners, are typically fats and oils, including tallow, hydrogenated vegetable oils, and cocoa butter.

Gum base typically also includes a filler component. The filler component modifies the texture of the gum base and aid processing. Examples of such fillers include magnesium and aluminum silicates, clay, alumina, talc, titanium oxide, cellulose polymers, and the like. Fillers are typically present in the amount of from 1% to 60% by weight.

Emulsifiers, which sometimes also have plasticizing properties, include glycerol monostearate, lecithin, and glycerol triacetate. In some embodiments, the inventors have unexpectedly found that a gum base with the combination of a relatively high amount of emulsifier with a lower molecular weight elastomer provides a desirable softness in chewing gums with low levels of liquid flavor. For example, combining polyvinyl acetate with a molecular weight of from about 12,000 gm/mol to about 18,000 gm/mol with an amount of glycerol triacetate at a level of from about 2% to about 5% w/w by weight of the gum base composition provides an acceptably soft chew texture in a chewing gum composition with a liquid flavor level of not more than 2% w/w by weight of the chewing gum composition. In some embodiments, the amount of emulsifier combined with lower molecular weight elastomers can be from about 2.5% to about 3.5% w/w by weight of the gum base composition when used in a chewing gum composition with a liquid flavor level of not more than 2% w/w by weight of the chewing gum composition.

Further, gum bases may also contain optional ingredients such as antioxidants, colors, and flavors.

The insoluble gum base may be present in the amount of from about 5% to 95% by weight of the chewing gum. In one embodiment, the insoluble gum base may present in the amount of from about 10% to 50% by weight of the gum base, and in another embodiment from about 20% to 40% by weight of the gum base.

Softeners are added to the chewing gum in order to optimize the chewability and mouth feel of the gum. Softeners, also known in the art as plasticizers or plasticizing agents, is generally present in amounts from about 0.5% to 15% by weight based on the total weight of the chewing gum composition. Softeners contemplated by the present invention include, for example, surfactants and/or emulsifiers such as lecithin and other surfactant/emulsifiers such as monoglycerides including distilled monoglycerides, mono and diglycerides, acid esters of mono and di glycerides including, but not limit to, acetylated monoglycerides, lactylated monoglycerides, succinated monoglycerides, citrated monoglycerides, polyglycerol esters, ceteareth-20, sorbitan esters, including but not limited to, sorbitan monostearate (Polysorbate 60), sorbitan monooleate (Polysorbate 80), sorbitan laurate (Polysorbate 20), sorbitan tristearate (Polysorbate 65), polyglyceryl laurate, glyceryl cocoate, sucrose esters, propylene glycol fatty acid esters, and combinations thereof. Polyglycerol esters can include triglyceryl monostearate, hexaglyceryl distearate, decaglyceryl monostearate, decaglyceryl dipalmitate, decaglyceryl monooleate, and polyglyceryl 10 hexaoleate. In some embodiments, suitable surfactants/emulsifiers include acetylated monoglycerides, distilled monoglycerides, and mono and diglycerides, and combinations thereof,

In some embodiments, the surfactants/emulsifiers are used in powder form while in other embodiments, the surfactant/emulsifiers are used in liquid form and in still other embodiments, the surfactant/emulsifiers include combinations of liquid and powdered forms. In some embodiments, the amount of powdered surfactant/emulsifier is from about 30% to about 80% w/w by weight of the surfactant/emulsifier combination composition while in other embodiments the amount of powdered surfactant/emulsifier is from about 35% to about 75% w/w by weight of the surfactant/emulsifier combination composition while in still other embodiments the amount of powdered surfactant/emulsifier is from about 50% to about 65% w/w by weight of the surfactant/emulsifier combination composition.

In some embodiments, the powdered surfactant/emulsifier can include acetylated monoglycerides, distilled monoglycerides, mono and di-glyceride blends, and combinations thereof. In some embodiments, the amount of powdered surfactant/emulsifier can be from about 1% to about 5% w/w by weight of the chewing gum composition while in other embodiments, the amount of powdered surfactant/emulsifier can be from about 1.5% to about 3% w/w by weight of the chewing gum composition, while in still other embodiments, the amount of powdered surfactant/emulsifier can be from about 1.8% to about 2.5% w/w by weight of the chewing gum composition.

In some embodiments, the amount of surfactant/emulsifier is from about 0.5% to about 10% w/w by weight of the chewing gum composition while in a preferred embodiment, the surfactant/emulsifier is in an amount of from about 1% to about 7% w/w by weight of the chewing gum composition and in an even more preferred embodiment, the amount of surfactant/emulsifier is from about 1.5% to about 3.5% w/w by weight of the chewing gum composition.

Further, aqueous sweetener solutions such as those containing sorbitol, hydrogenated starch hydrolysate, corn syrup, and combinations thereof may be used as softeners and binding agents in the gum. In some embodiments, the amount of aqueous sweetener softeners can be from about 2% to about 10% w/w by weight of the chewing gum composition while in other embodiments, the amount of aqueous sweetener softeners can be from about 3% to about 7% w/w by weight of the chewing gum composition while in still other embodiments the amount of aqueous sweetener softeners can be from about 4% to about 7% w/w by weight of the chewing gum composition.

The chewing gum compositions of the present invention may be coated or uncoated and be in the form or slabs, sticks, pellets, balls and the like. The composition of the different forms of the chewing gum compositions will be similar but may vary with regard to the ratio of the ingredients. For example, coated gum compositions may contain a lower percentage of softeners. Pellets and balls have a small chewing gum core, which is then coated with either a sugar solution or a sugarless solution to create a hard shell. Slabs and sticks are usually formulated to be softer in texture than the chewing gum core.

Coating techniques for applying a coating for a chewing gum composition such as pan and spray coating are well known. In one embodiment, coating with solutions adapted to build a hard candy layer can be employed. Both sugar and sugar alcohols may be used for this purpose together with high intensity sweeteners, colorants, flavorants and binders. In some embodiments, the flavor added to the coating solution can be the same or in the same flavor family as the flavor in the chewing gum core. Flavor families can be considered categories of flavors that have similar characteristics. Some flavor families can include hit flavors, mint flavors, spice flavors, brown flavors, and savory flavors. For example, a peppermint flavor in the chewing gum core can also be included in the coating solution to provide a chewing gum with an initial peppermint taste followed by a longer lasting peppermint flavor. Similarly, a hit flavor such as orange can be included in the chewing gum core while another hit flavor in the family of hit flavors such as raspberry can be included in the coating solution. In other embodiments, the flavor added to the coating solution can be a different flavor or in a different flavor family as the flavor in the chewing gum core. For example, a spearmint flavor can be included in the chewing gum core when a strawberry flavor is included in the coating solution to provide a chewing gum with an initial hit taste followed by a longer lasting spearmint flavor. Similarly, a hit flavor such as orange from the family of hit flavors can be included in the chewing gum core while a cinnamon flavor from the family of spice flavors can be included in the coating solution.

Other components may be added in minor amounts to the coating syrup and include moisture absorbing compounds, anti-adherent compounds, dispersing agents and film forming agents. The moisture absorbing compounds suitable for use in the coating syrups include mannitol or dicalcium phosphate. Examples of useful anti-adherent compounds, which may also function as a filler, include talc, magnesium trisilicate and calcium carbonate. These ingredients may be employed in amounts of from about 0.5% to 5% by weight of the syrup. Examples of dispersing agents, which may be employed in the coating syrup, include titanium dioxide, talc or other anti-adherent compounds as set forth above.

The coating syrup is usually heated and a portion thereof deposited on the cores. Usually a single deposition of the coating syrup is not sufficient to provide the desired amount or thickness of coating and second, third or more coats of the coating syrup may be applied to build up the weight and thickness of the coating to desired levels with layers allowed to dry in-between coats.

A method of preparing a chewing gum composition is by adding the various chewing gum ingredients to any commercially available mixer known in the art, such as a batch mixer and/or an extruder. After the ingredients have been thoroughly mixed, the gum base is discharged from the mixer and shaped into the desired form such as by rolling into sheets and cutting into sticks, extruding into chunks, or casing into pellets.

Generally, the ingredients are mixed by first melting the gum base and adding it to the running mixer. The gum base may also be melted into the mixer itself. Colors or emulsifiers may also be added at this time. A softener may be added to the mixer at this time, along with syrup and a portion of the bulking agent. Further parts of the bulking agent are then added to the mixer. Flavorants are typically added with the final portion of the bulking agent and in the case of the present invention the at least three flavor compositions can be added simultaneously or added separately, e.g., all three added separately or two added separately from the third. Other optional ingredients are added in the batch in a typical fashion, well known to those of ordinary skill in the art.

The entire mixing procedure typically takes from five to fifteen minutes, but longer mixing times may be required. Those skilled in the art will recognize that many variations of the above-described procedure may be followed.

In certain embodiments, the time in which the gum is mixed after the third flavor composition is added is controlled more tightly, such as not more than 8 minutes for a batch mixer and from 5 to 30 seconds in a continuous extruder. Without being limited to theory, the inventors believe that by limiting the amount of time that the gum is mixed after the third flavor composition is added, one avoids and/or attenuates the break down of the structure of the delivery system that comprises the third flavor composition.

After the ingredients are mixed, the gum mass may be formed into a variety of shapes and products. For example, the ingredients may be formed into pellets or balls and used as cores to make a coated chewing gum product. However, any type of chewing gum product can be utilized with the present invention.

If a coated product is desired, the coating may contain ingredients such as flavorants, artificial sweeteners, dispersing agents, coloring agents, film formers and binding agents. Flavorants in the coating, include those commonly known in the art such as essential oils, synthetic flavors, or mixtures thereof, including but are not limited to, oils derived from plants and hits such as citrus oils, hit essences, peppermint oil, spearmint oil, other mint oils, clove oil, oil of wintergreen, anise and the like. The flavorants may also be added to the coating syrup in an amount such that the coating may be present in amounts of from about 0.2% to 1.2% by weight flavoring agent. In another embodiment. the coating may be present in amounts from about 0.7% to 1.0% by weight flavoring agent.

Dispersing agents are often added to syrup coatings for the purpose of whitening and tack reduction. Dispersing agents contemplated by the present invention to be employed in the coating syrup include titanium dioxide, talc, or any other anti-stick compound. The dispersing agent may be added to the coating syrup in an amount such that the coating contains from about 0.1% to 1.0%, including 0.2, 0.3, 0.4, 0.5, 0.6, 0.7, 0.8, 0.9 and all values and ranges there between, for example, from about 0.3% to 0.6% by weight of the agent.

Coloring agents may be added directly to the coating syrup in dye or lake form. Coloring agents contemplated by the present invention include food quality dyes. Film formers may be added to the coating syrup include methylcellulose, carboxymethyl cellulose, ethyl cellulose, hydroxyethyl cellulose, and the like or combinations thereof. Binding agents may be added either as an initial coating on the chewing gum center or may be added directly to the coating syrup. Binding agents contemplated by the present invention include gum Arabic, gum talha, gelatin, vegetable gums, and the like. The binding agents, when added to the coating syrup, are typically added in amounts from about 0.5% to 10% by weight.

### EXAMPLES

Chewing Gum

| | Examples | | | | | | |
|---|---|---|---|---|---|---|---|
| | 1 | 2 | 3 | 4 | 5 | 6 | 7 |
| | % w/w by weight of the chewing gum composition | | | | | | |
| Ingredient | % w/w | % w/w | % w/w | % w/w | % w/w | % w/w | % w/w |
| Gum Base | 20-35 | 20-35 | 20-35 | 20-35 | 20-35 | 20-35 | 20-35 |
| Sorbitol | q.s. | q.s. | q.s. | q.s. | q.s. | q.s. | q.s. |
| Mannitol | 8-15 | | 8-15 | 8-15 | | 8-15 | 8-15 |
| Xylitol | 8-15 | 8-15 | | 8-15 | 8-15 | | 8-15 |
| Isomalt | | 8-15 | | | 8-15 | | |
| Erythritol | | | 8-15 | | | 8-15 | |
| Lecithin | 0.1-1.0 | 0.1-1.0 | 0.1-1.0 | 0.1-1.0 | 0.1-1.0 | 0.1-1.0 | 0.1-1.0 |
| Glycerin | 5-15 | 5-15 | 5-15 | 5-15 | 5-15 | 5-15 | 5-15 |
| Emulsifiers | 0.5-1.5 | 0.5-1.5 | 0.5-1.5 | 0.5-1.5 | 0.5-1.5 | 0.5-1.5 | 0.5-1.5 |
| Aspartame | 0.1-0.5 | 0.1-0.5 | 0.1-0.5 | 0.1-0.5 | 0.1-0.5 | | |
| Acesulfame-K | | 0.1-0.5 | | 0.1-0.5 | | | |
| Sucralose | | | | | | 0.1-0.5 | 0.1-0.5 |
| Encapsulated | 2.0-3.0 | 2.0-3.0 | 2.0-3.0 | 2.0-3.0 | 2.0-3.0 | 2.0-3.0 | 2.0-3.0 |
| Aspartame | | | | | | | |
| Encapsulated | 1.2-1.5 | 1.2-1.5 | 1.2-1.5 | 1.2-1.5 | 1.2-1.5 | 1.2-1.5 | 1.2-1.5 |
| Acesulfame-K | | | | | | | |
| Encapsulated | | | 0.5-1.0 | 0.5-1.0 | | | 0.5-1.0 |
| Sucralose | | | | | | | |
| Food Acids | 0-1.5 | 0-1.5 | 0-1.5 | 0-1.5 | 0-1.5 | 0-1.5 | 0-1.5 |
| Liquid fruit flavor | | 0.1-0.5 | 0.1-0.5 | 0.1-0.5 | 0.1-0.5 | | 0.1-0.5 |
| Initial delivery | 2.5-3.0 | 1.5-2.5 | 1.5-2.5 | 1.5-2.5 | 1.5-2.5 | 2.5-3.0 | 1.5-2.5 |
| fruit flavor | | | | | | | |
| Initial delivery | | | | 0.1-1.0 | | | |
| mint flavor | | | | | | | |
| Initial delivery | | | | | 0.1-1.0 | | |
| fruit mint flavor | | | | | | | |
| Intermediate | | 0.2-1.0 | 0.2-1.0 | | | | 0.2-1.0 |
| delivery fruit | | | | | | | |
| flavor | | | | | | | |
| Intermediate | | | 0.2-1.0 | | | | |
| delivery mint flavor | | | | | | | |
| Delayed delivery | 2.5-3.5 | 2.5-3.5 | 2.5-3.5 | 2.5-3.5 | 2.5-3.5 | 2.5-3.5 | 2.5-3.5 |
| mint flavor | | | | | | | |

Chewing Gum

| | Examples | | | | | | |
|---|---|---|---|---|---|---|---|
| | 8 | 9 | 10 | 11 | 12 | 13 | 14 |
| | % w/w by weight of the chewing gum composition | | | | | | |
| Ingredient | % w/w | % w/w | % w/w | % w/w | % w/w | % w/w | % w/w |
| Gum Base | 20-35 | 20-35 | 20-35 | 20-35 | 20-35 | 20-35 | 20-35 |
| Sorbitol | q.s. | q.s. | | | | q.s. | q.s. |
| Mannitol | | | | | | | 8-15 |
| Xylitol | 8-15 | 8-15 | 8-15 | 8-15 | 8-15 | | 8-15 |
| Isomalt | 8-15 | 8-15 | | | | | |
| Erythritol | | | | | | 8-15 | |
| Maltitol Syrup | 2-5 | | | | | 2-5 | |
| Hydrogenated Starch | | 2-5 | | | | | 2-5 |
| Hydrolysate | | | | | | | |
| Sucrose | | | q.s. | q.s. | q.s. | 8-15 | |
| Corn Syrup | | | 8-15 | 8-15 | 8-15 | | |
| Triacetin | 0.2-0.5 | 0.2-0.5 | 0.2-0.5 | 0.2-0.5 | 0.2-0.5 | | |
| Lecithin | 0.1-1.0 | 0.1-1.0 | 0.1-1.0 | 0.1-1.0 | 0.1-1.0 | 0.1-1.0 | 0.1-1.0 |
| Glycerin | 3-15 | 3-15 | 3-15 | 3-15 | 3-15 | 3-15 | 3-15 |
| Emulsifiers | 1.5-3.5 | 1.5-3.5 | 1.5-3.5 | 1.5-3.5 | 1.5-3.5 | 1.5-3.5 | 1.5-3.5 |
| Aspartame | 0.05-0.5 | 0.05-0.5 | 0.05-0.5 | 0.05-0.5 | | 0.05-0.5 | |
| Acesulfame-K | | | | 0.05-0.5 | | | |
| Sucralose | 0.05-0.5 | 0.05-0.5 | 0.05-0.5 | | | 0.05-0.5 | 0.1-0.5 |
| Encapsulated | 2.0-3.0 | 2.0-3.0 | 1.0-3.0 | 1.0-3.0 | 1.0-3.0 | 1.0-3.0 | 2.0-3.0 |
| Aspartame | | | | | | | |
| Encapsulated | 1.0-1.5 | 1.0-1.5 | 1.0-1.5 | 1.2-1.5 | 1.2-1.5 | 1.0-1.5 | 1.2-1.5 |
| Acesulfame-K | | | | | | | |
| Encapsulated | 0.05-0.5 | 0.05-0.5 | 0.05-0.5 | 0.05-0.5 | 0.05-0.5 | 0.05-0.5 | 0.5-1.0 |
| Sucralose | | | | | | | |
| Food Acids | 0-1.5 | 0-1.5 | 0-1.5 | 0-1.5 | 0-1.5 | 0-1.5 | 0-1.5 |
| Liquid fruit flavor | 0.1-0.5 | 0.1-0.5 | 0.1-0.5 | 0.1-0.5 | 0.1-0.5 | | 0.1-0.5 |
| Initial delivery fruit | 1.5-3.0 | 1.5-3.0 | 1.5-3.0 | 1.5-2.5 | 1.5-2.5 | 2.5-3.0 | 1.5-2.5 |
| flavor | | | | | | | |
| Initial delivery mint | | | | 0.1-1.0 | | | |
| flavor | | | | | | | |
| Initial delivery fruit | | | | | 0.1-1.0 | | |
| mint flavor | | | | | | | |
| Intermediate delivery | 2.0-3.0 | 2.0-3.0 | 2.0-3.0 | | | | 0.2-1.0 |
| fruit flavor | | | | | | | |
| Intermediate delivery | | | | | | 0.2-1.0 | |
| mint flavor | | | | | | | |
| Delayed delivery mint | 2.5-4.5 | 2.5-4.5 | 2.5-4.5 | 2.5-4.5 | 2.5-4.5 | 2.5-4.5 | 2.5-4.5 |
| flavor | | | | | | | |

Chewing Gum [Actual Examples]

| | Examples | | | | | |
|---|---|---|---|---|---|---|
| | 15 | 16 | 17 | 18 | 19 | 20 |
| Ingredient | % w/w | % w/w | % w/w | % w/w | % w/w | % w/w |
| Gum Base | 27 | 27 | 27 | 27 | 27 | 27 |
| Sorbitol | q.s. | q.s. | q.s. | q.s. | q.s. | q.s. |
| Xylitol | 9.6 | 9.6 | 9.6 | 9.6 | 9.6 | 9.6 |
| Isomalt | 11 | 11 | 11 | 11 | 11 | 11 |
| Maltitol Syrup | 4.75 | 4.75 | 4.75 | 4.75 | 4.75 | 4.75 |
| Triacetin | 0.32 | 0.32 | 0.32 | 0.32 | 0.32 | 0.32 |
| Lecithin | 0.5 | 0.5 | 0.5 | 0.5 | 0.5 | 0.5 |
| Glycerin | 4.2 | 4.2 | 4.2 | 4.2 | 4.2 | 4.2 |
| | 3.1 | 3.1 | 3.1 | 3.1 | 3.1 | 3.1 |
| Emulsifiers | | | | | | |
| Aspartame | .35 | .35 | .35 | .35 | .35 | .35 |
| Sucralose | .2 | .2 | .2 | .2 | .2 | .2 |
| Encapsulated | 2.76 | 2.76 | 2.76 | 2.76 | 2.76 | 2.76 |
| Aspartame | | | | | | |
| Encapsulated | 1.36 | 1.36 | 1.36 | 1.36 | 1.36 | 1.36 |
| Acesulfame-K | | | | | | |
| Encapsulated | 0.8 | 0.8 | 0.8 | 0.8 | 0.8 | 0.8 |
| Sucralose | | | | | | |
| Food Acids | 0.47 | 0.47 | 0.47 | 0.47 | 0.47 | 0.47 |
| Liquid fruit | 0.2 | 0.2 | 0.2 | 0.2 | | |
| flavor - | | | | | | |
| strawberry | | | | | | |
| Initial delivery | 0.5 | 0.5 | 0.5 | 0.5 | | |
| fruit flavor - | | | | | | |
| strawberry | | | | | | |
| Intermediate | 4.0 | 4.0 | 4.0 | 4.0 | | |
| delivery | | | | | | |
| fruit flavor - | | | | | | |
| strawberry | | | | | | |
| Delayed | 3.5 | 3.5 | 3.5 | 3.5 | | |
| delivery | | | | | | |
| mint flavor - | | | | | | |
| mint with | | | | | | |
| cooling | | | | | | |
| Liquid fruit | | | | | 0.2 | 0.2 |
| flavor - citrus | | | | | | |
| Initial delivery | | | | | 0.5 | 0.5 |
| fruit flavor - | | | | | | |
| citrus | | | | | | |
| Intermediate | | | | | 4.0 | 4.0 |
| delivery fruit | | | | | | |
| flavor - citrus | | | | | | |
| Delayed | | | | | 3.5 | 3.5 |
| delivery mint | | | | | | |
| flavor - mint | | | | | | |
| with cooling | | | | | | |

Examples 15-18 differed in the type of liquid hit flavor and the type of delayed mint flavor.

Examples 19 & 20 differed in the type of delayed mint flavor.

Experimental Results:

Consumer testing was conducted was conducted with over 100 participants screened for chewing gum use and flavor type use. Each participant evaluated the test products during a 30 minute chew period with a 10 minute rest period in between samples. Participants were shown a product concept statement describing a chewing gum product that provides a sequential flavor release taste experience.

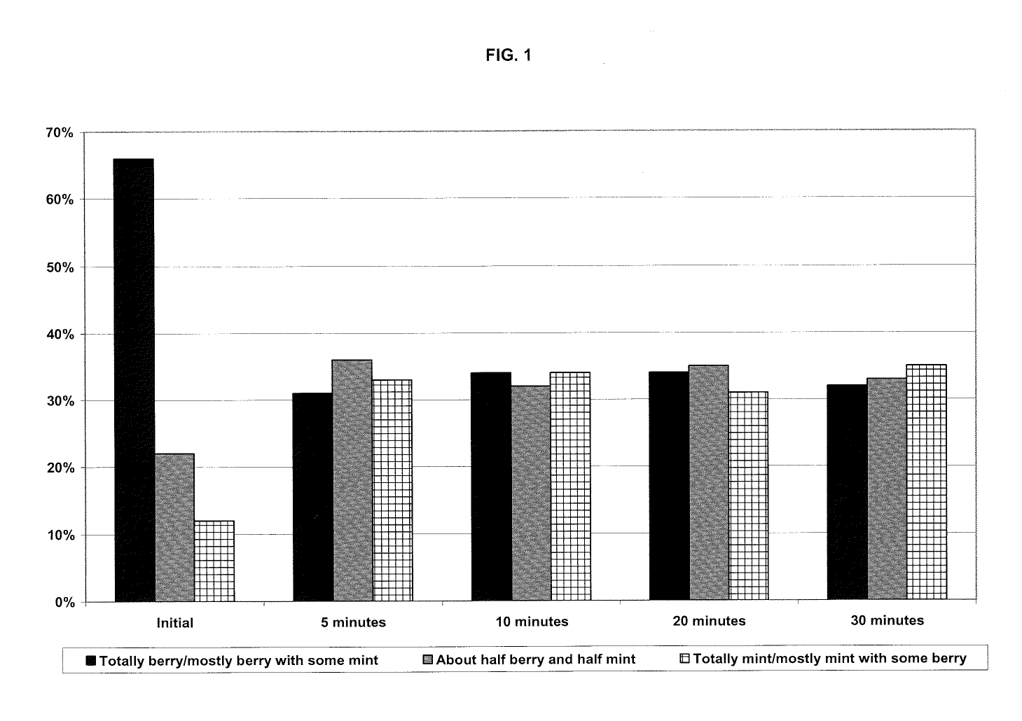

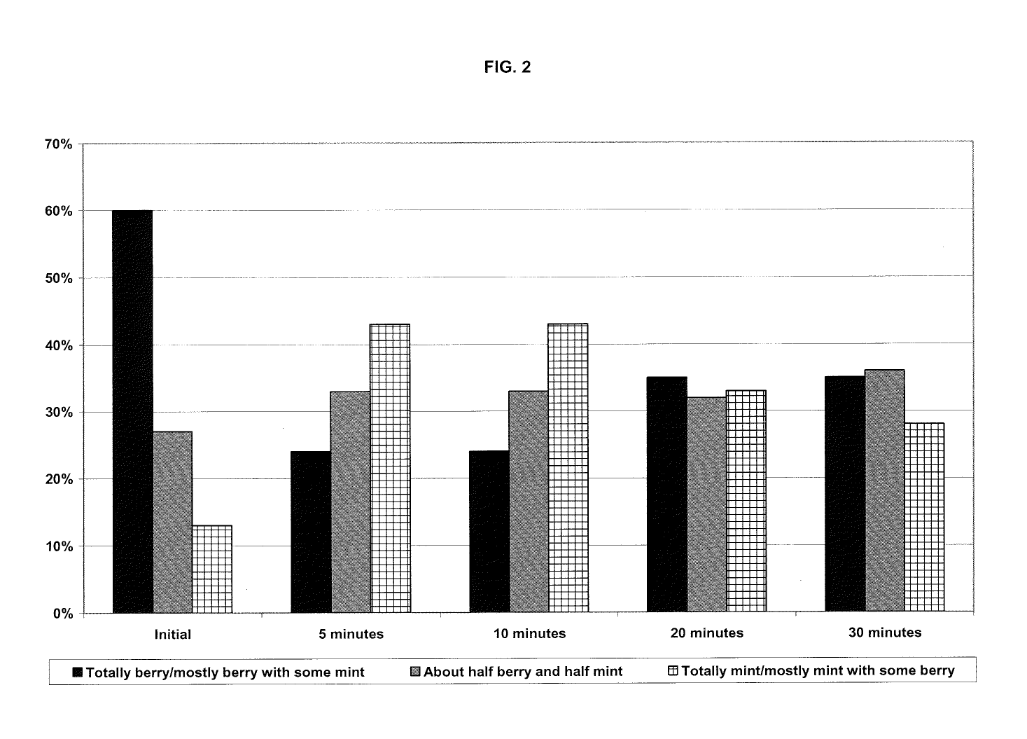

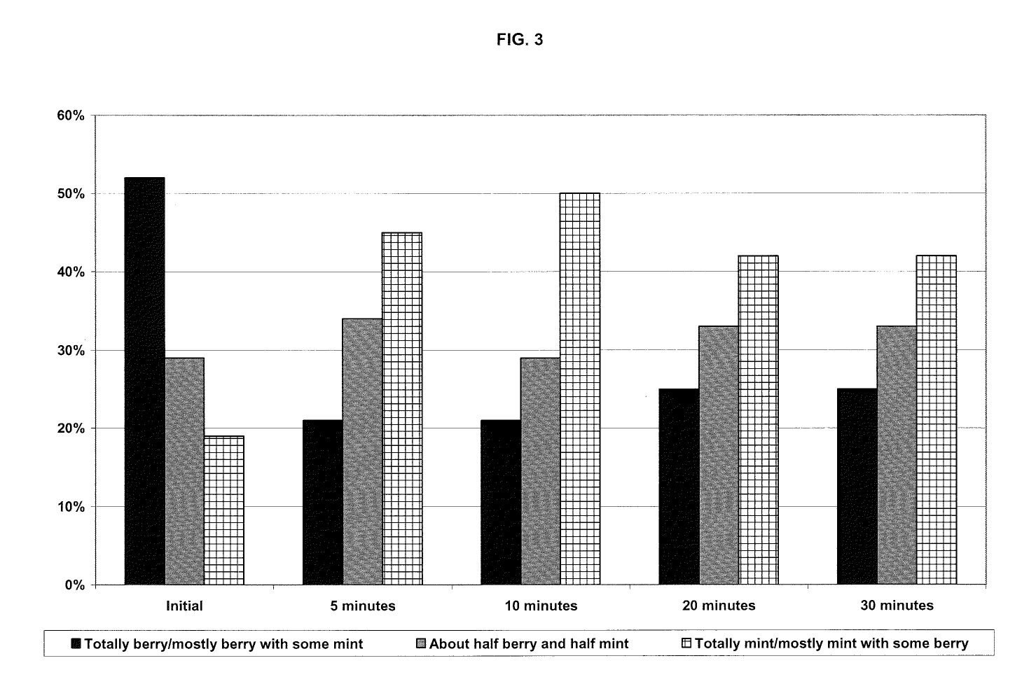

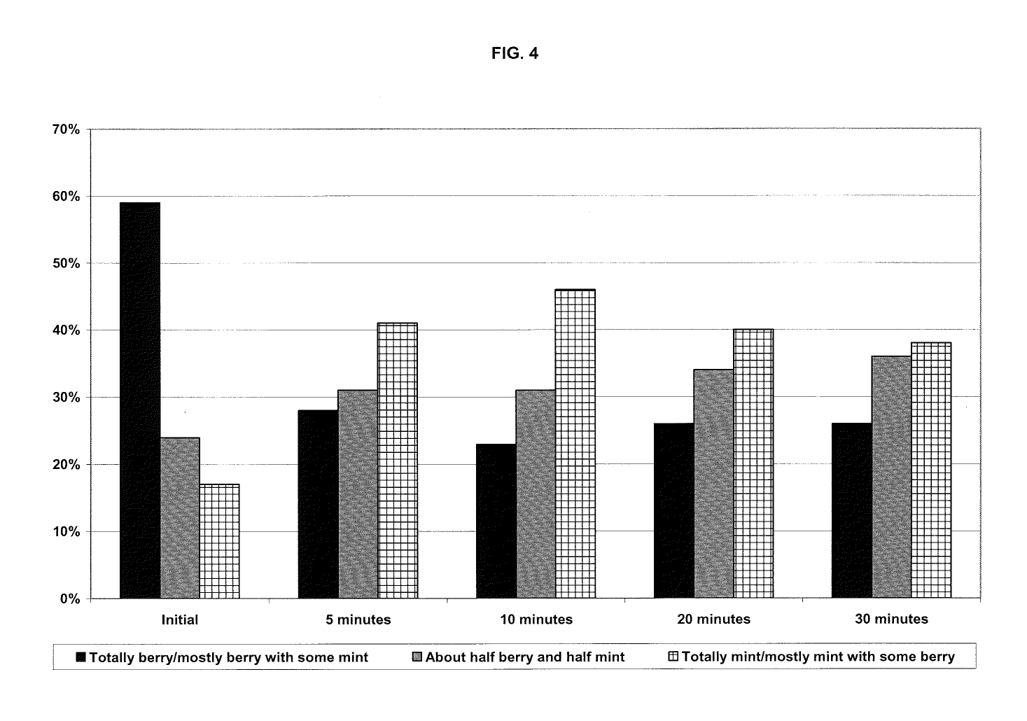

Strawberry mint (examples 15-18). The results of the consumer testing for Examples 15-18 are depicted in FIGS. 1-4.

Even though the test participants were untrained consumers, all the samples showed a sequential flavor release from more hit notes to more mint notes with examples over a 30 minute chew period with acceptable half hit and half mint notes once the initial, predominating fruit flavor subsided. Example 18 demonstrated the clearest transition from fruit to mint while examples 15 and 16 showing a transition from fruit to half fruit/half mint to mint back to fruit again over the 30 minute chew time.

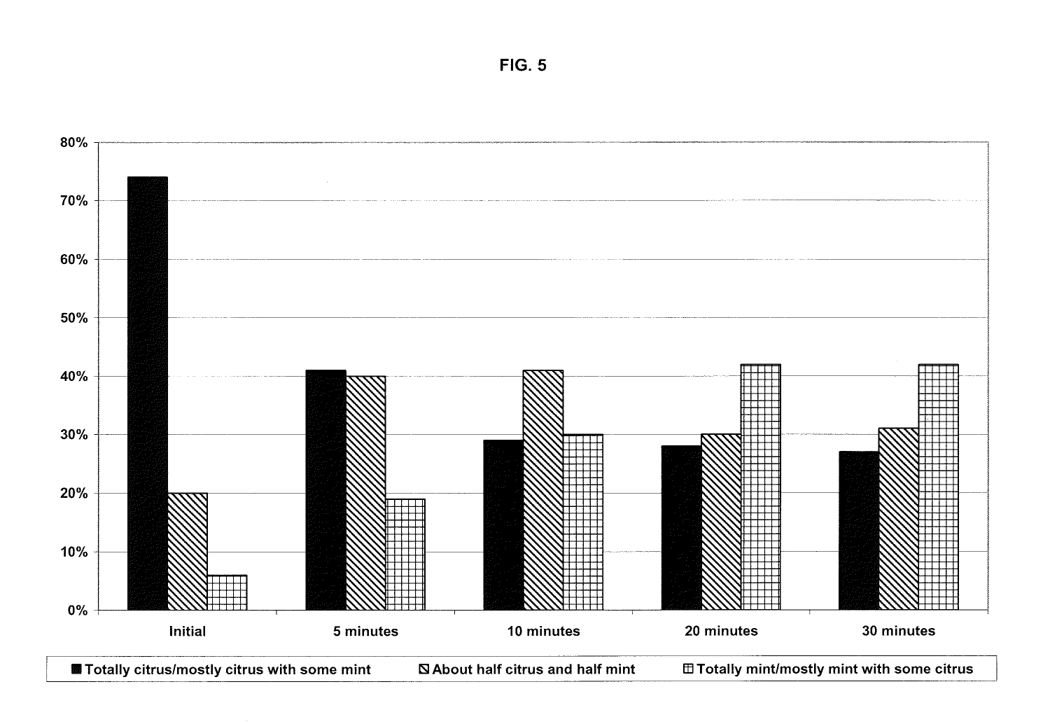

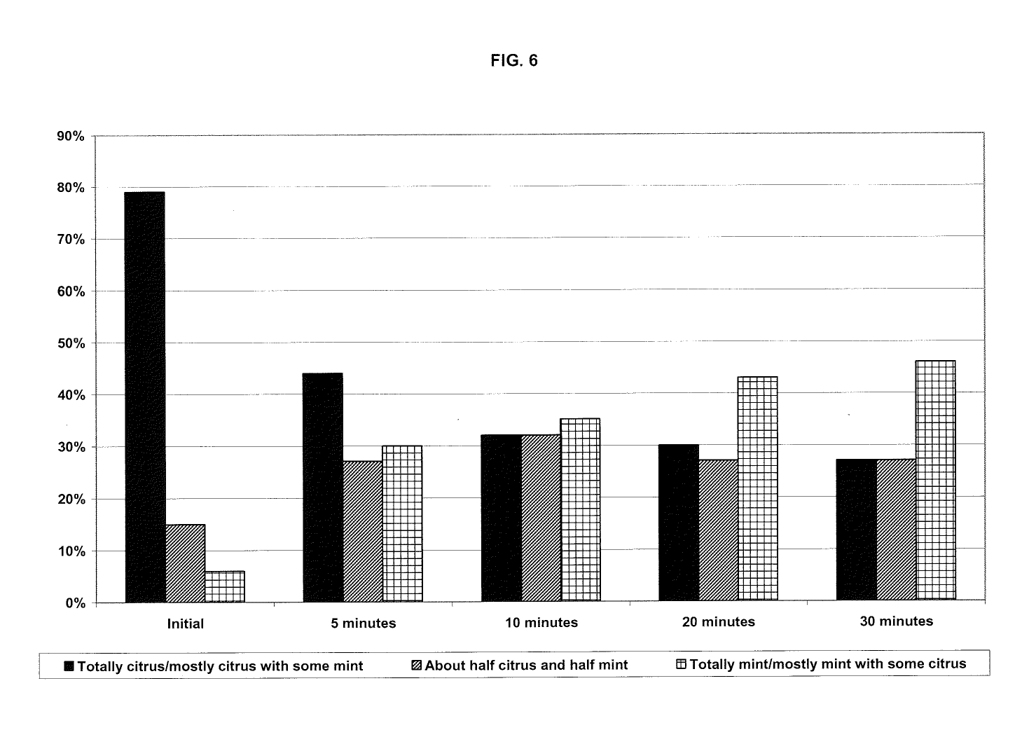

Citrus mint (examples 19-20). The results of the consumer testing for Examples 19 and 20 are depicted in FIGS. 5 and 6.

Here again, both examples showed a sequential flavor release from more fruit notes to more mint notes with examples over a 30 minute chew period with acceptable half fruit and half mint notes once the initial, predominating fruit flavor subsided. Example 20 demonstrated the clearest transition from fruit to mint.

Example 21: Chewing Gum
Gum base: 20-40%
Polyols and bulking agents (sugar): 10-50%
Flavoring compound: 0.01-10%
High Intensity Sweeteners: 0.01-10%
Non-hydrated hydrocolloid (including encapsulated): 1.5% -20% (or 2-5%)

The chewing gum is prepared by compounding the gum base and then adding the flavors, sweeteners and hydrocolloid.

Obviously, numerous modifications and variations of the present invention are possible in light of the above teachings. It is therefore to be understood that within the scope of the appended claims, the invention may be practiced otherwise than as specifically described herein.

1. A chewing gum composition, comprising
a gum base and at least a first, second and third flavor composition
wherein
the at least one first flavor composition begins to release from the chewing gum composition when the chewing gum composition is masticated,
the at least one second flavor composition begins to release after the at least one first flavor composition has begun to release, and
the at least one third flavor composition releases after the second flavor composition begins to release, wherein the third flavor composition comprises a particulate delivery system comprising a polymeric encapsulating material and a flavor and having a particle size distribution of at least 80% of particles greater than 425 μm and at least 80% of particles less than 1000 μm.

2. The chewing gum composition of claim 1, wherein the at least one first flavor composition has at least one first peak flavor intensity after the chewing gum composition is masticated and wherein the at least one second flavor composition reaches at least a second peak flavor intensity after the at least one first flavor composition reaches the at least one first peak flavor intensity.

3. The chewing gum composition of claim 2, wherein the at least one third flavor composition reaches at least one third peak flavor intensity after the at least one second flavor composition reaches the at least one second peak flavor intensity.

4. The chewing gum composition of claim 1, wherein the at least one second flavor composition begins to release when the at least one second flavor composition has released for from 15 to 40 seconds.

5. The chewing gum composition of claim 1, wherein the at least one third flavor composition begin to release when the at least one second flavor composition has released for from 15 to 40 seconds.

6. The chewing gum composition of claim 1, wherein the second flavor composition begins to release when the at least one first flavor composition has reached at least from 50 to 100% of the at least one peak flavor intensity.

7. The chewing gum composition of claim 1, wherein the at least one third flavor composition begins to release when the at least one second flavor composition has reached at least from 50 to 100% of the at least one peak flavor intensity.

8. The chewing gum composition of claim 1, wherein the at least one second flavor composition begins to release when at least about 50% of the at least one first flavor composition has released from the chewing gum composition.

9. The chewing gum composition of claim 1, wherein the at least one third flavor composition begins to release when at least about 50% of the at least one second composition has released from the chewing gum composition.

10. The chewing gum composition of claim 1, wherein the at least one first flavor composition comprises a fruit flavor.

11. The chewing gum composition of claim 1, wherein the at least one second flavor composition comprises a fruit flavor and a mint flavor.

12. The chewing gum composition of claim 1, wherein the at least one third flavor composition comprises a mint flavor.

13. The chewing gum composition of claim 1, wherein the at least one first flavor composition comprises a liquid flavor.

14. The chewing gum composition of claim 5, wherein the liquid flavor is a fruit flavor.

15. The chewing gum composition of claim 5, wherein the liquid flavor is present in an amount of 0.4% w/w.

16. The chewing gum composition of claim 1, wherein the at least one second flavor composition comprises a particulate flavor delivery system.

17. The chewing gum composition of claim 1, wherein the at least one third flavor composition comprises a particulate delivery system comprising flavor, gelatin, and fat.

18. The chewing gum composition of claim 1, wherein the at least one third flavor particulate composition has a tensile strength of at least 6,500 psi.

19. The chewing gum composition of claim 1, wherein one or more of the first, second and third compositions comprises one or more sweeteners.

20. The chewing gum composition of claim 1, wherein said gum base includes at least 7% W/W by weight of said gum base of butyl rubber.

21. The chewing gum composition of claim 1, wherein said third flavor includes N-(4-cyanomethylphenyl)-p-menthane carboxamide.

22. The chewing gum composition of claim 1, further comprising at least one hydrocolloid.

23. The chewing gum composition of claim 22, wherein the hydrocolloid is present in an amount of from 1.5 to 20% by weight of the chewing gum composition,

24. The chewing gum composition of claim 22, wherein the hydrocolloid is crosslinked and at least partially encapsulates one or more flavors.

25. The chewing gum composition of claim 24, wherein the crosslinked hydrocolloid encapsulates at least one flavor in the at least one second flavor composition.

26. The chewing gum composition of claim 22, wherein the hydrocolloid is selected from the group consisting of low viscosity alginate, medium viscosity alginate, high viscosity alginate, propylene glycol alginate, carrageenan, guar gum, xanthan gum, pectin, hydroxpropyl methyl cellulose, pullulan, gum Arabic, agar, carboxymethyl cellulose, konjac, gellan gum, gelatin, and combinations thereof.

27. The chewing gum composition of claim 22, wherein the hydrocolloid is in dry powder form.

28. The chewing gum composition of claim 22, wherein the hydrocolloid is in slurry form.

29. The chewing gum composition of claim 22, wherein the hydrocolloid is in film form.

30. A method of making a chewing gum composition, comprising
mixing a water-insoluble gum base portion with at least a first, second and third flavor compositions wherein
the at least one first flavor composition begins to release from the chewing gum composition when the chewing gum composition is masticated,
the at least one second flavor composition begins to release after the at least one first flavor composition has begun to release, and
the at least one third flavor composition releases after the second flavor composition begins to release, wherein the third flavor composition comprises a particulate delivery system comprising a polymeric encapsulating material and a flavor and having a particle size distribution of at least 80% of particles greater than 425 μm and at least 80% of particles less than 1000 μm.

31. The method of claim 30, wherein the mixing is performed in a batch mixer.

32. The method of claim 30, wherein the mixing is performed in an extruder.

33. The method of claim 30, wherein the mixing is performed in a batch mixer and an extender.

34. The method of claim 30, wherein the first, second and third flavor compositions are mixed with the gum base simultaneously.

35. The method of claim 30, wherein the first, second and third flavor compositions are mixed with the gum base separately.

36. The chewing gum composition of claim 1, wherein the third flavor composition a particle size distribution of at least 80% of particles greater than 600 μm and at least 80% of particles less than 850 μm.

37. The chewing gum composition of claim 1, wherein the third flavor composition comprises a particle size distribution of 100% greater than 425 μm and at least 100% of particles less than 1000 μm.

38. The chewing gum composition of claim 1, wherein the third flavor composition comprises a particle size distribution of 100% of particles greater than 600 μm and 100% of particles less than 850 μm.
